(19) United States
(12) Patent Application Publication
(10) Pub. No.: US 2023/0085247 A1
(43) Pub. Date: Mar. 16, 2023

(54) SUPERCAPACITORS WITH COBALT TETRAOXIDE-COATED NANOFIBER YARN ELECTRODES

(71) Applicant: The Texas A&M University System, College Station, TX (US)

(72) Inventors: Ahmad Amiri, College Station, TX (US); Andreas A. Polycarpou, College Station, TX (US); Kian Bashandeh, College Station, TX (US); Mohammad G. Naraghi, Cypress, TX (US)

(21) Appl. No.: 17/945,382

(22) Filed: Sep. 15, 2022

Related U.S. Application Data
(60) Provisional application No. 63/244,637, filed on Sep. 15, 2021.

(51) Int. Cl. H01G 11/36; H01G 11/24; H01G 11/40

(52) U.S. Cl. CPC H01G 11/36; H01G 11/24; H01G 11/40

(57) ABSTRACT

In an embodiment, the present disclosure pertains to a metal oxide-coated nanofiber yarn. In some embodiments, the metal oxide-coated nanofiber yarn includes a plurality of twisted carbon nanofibers. In some embodiments, each twisted carbon nanofiber includes a porous hollow fiber. In some embodiments, each twisted carbon nanofiber includes metal oxide nanoparticles coated on a surface thereof. In some embodiments, an outer surface of each twisted carbon nanofiber, an inner surface of each twisted carbon nanofiber, and holes or channels of a main fiber skeleton of the plurality of twisted carbon nanofibers with the possibility of transferring a metal ion are covered by the metal oxide nanoparticles. In a further embodiment, the present disclosure pertains to methods of making the metal oxide-coated nanofiber yarn. In an additional embodiment, the present disclosure pertains to a structural supercapacitor utilizing the metal oxide-coated nanofiber yarn.

### TECHNICAL FIELD

This patent application claims priority from, and incorporates by reference the entire disclosure of, U.S. Patent Application No. 63/244,637 filed on Sep. 15, 2021.

### TECHNICAL FIELD

The present disclosure relates generally to structural supercapacitors and more particularly, but not by way of limitation, to supercapacitors with cobalt tetraoxide-coated nanofiber yarn electrodes.

### BACKGROUND

This section provides background information to facilitate a better understanding of the various aspects of the disclosure. It should be understood that the statements in this section of this document are to be read in this light, and not as admissions of prior art.

Developing an efficient all-solid-state structural supercapacitor with simultaneous high load bearing and energy storage capabilities for reducing weight/volume in weight-sensitive and volume-restricted applications remains challenging. Relying only on the sole mechanism of the electrical double layer and the existing trade-offs between load bearing and energy storage requirements have limited the overall performance of carbon-based structural electrodes. Herein, the development of ultrafine Co₃O₄-coated highly-porous, hollow, N-doped carbon nanofiber yarns (Co-NCFY) as a high performance multifunctional structural electrode with a remarkable performance index representing mechanical and electrochemical properties is described to address these challenges. The devices of the present disclosure are designed to benefit from both the electric double layer and Faradaic reactions to store energy. The Co-NCFY show promising electrochemical properties (capacitance of 713 F g⁻¹ at 1 mV s⁻¹, desirable cycling stability of >92% at 20 A g⁻¹ after >8000 cycles, energy density of 45.4 Wh kg⁻¹ at a power density of 209 W kg⁻¹), and load-bearing capability (strength of 87.4 MPa and young modulus of 26.4 GPa). Taking into account both electrochemical and mechanical properties, the Co-NCFY outperform recently reported structural electrode materials (FIG. 1A). These attractive attributes make Co-NCFY a unique structural electrode material for efficient structural energy storage devices.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure pertains to a metal oxide-coated nanofiber yarn. In some embodiments, the metal oxide-coated nanofiber yarn includes a plurality of twisted carbon nanofibers. In some embodiments, each twisted carbon nanofiber is composed of a porous hollow fiber. In some embodiments, each twisted carbon nanofiber includes metal oxide nanoparticles coated on a surface thereof. In some embodiments, an outer surface of each twisted carbon nanofiber, an inner surface of each twisted carbon nanofiber, and holes or channels of a main fiber skeleton of the plurality of twisted carbon nanofibers with the possibility of transferring a metal ion are covered by the metal oxide nanoparticles.

In a further embodiment, the present disclosure pertains to a method of making a metal oxide-coated nanofiber yarn. Generally, the method includes coaxial electrospinning of polymeric precursors, twisting polymeric fibrous mats formed via the coaxial electrospinning to thereby form a plurality of twisted carbon nanofibers. In some embodiments, each twisted carbon nanofiber is composed of a porous hollow fiber. In some embodiments, the method further includes activating the plurality of twisted carbon nanofibers, decorating the plurality of twisted carbon nanofibers with metal oxide nanoparticles, and doping the plurality of twisted carbon nanofibers.

In an additional embodiment, the present disclosure pertains to a structural supercapacitor. In some embodiments, structural supercapacitor includes a plurality of twisted carbon nanofibers.

In some embodiments, each twisted carbon nanofiber is composed of a porous hollow fiber. In some embodiments, each twisted carbon nanofiber includes metal oxide nanoparticles coated on a surface thereof. In some embodiments, an outer surface of each twisted carbon nanofiber, an inner surface of each twisted carbon nanofiber, and holes or channels of a main fiber skeleton of the plurality of twisted carbon nanofibers with the possibility of transferring a metal ion are covered by the metal oxide nanoparticles. In some embodiments, the structural supercapacitor further includes an electrolyte medium and a current collector.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1A illustrates an Abby chart (reported magnitude of energy storage) and FIG. 1B illustrates a structural electrode according to aspects of the present disclosure.

FIG. 2 illustrates a method of preparation of Co-NCFY structural electrodes according to aspects of the present disclosure.

FIG. 3A illustrates Raman spectra and FIG. 3B illustrates XPS survey spectra of P-CFY, A-CFY, Co-CFY, and Co-NCFY; FIGS. 3C-3L illustrate high-resolution XPS spectra of P-CFY, A-CFY, Co-CFY, Co-NCFY, Co-CFY Co-NCFY, P-CFY, A-CFY, Co-CFY, and Co-NCFY, respectively.

FIG. 4A illustrates CV curves of P-CFY, A-CFY, Co-CFY, and Co-NCFY at a scan rate of 100 mV s⁻¹; FIG. 4B illustrates specific capacitance of P-CFY, A-CFY, Co-CFY, and Co-NCFY at various scan rates; FIG. 4C illustrates GCD curves for P-CFY, A-CFY, Co-CFY, and Co-NCFY at a current density of 1 A g⁻¹; FIG. 4D illustrates Ragone plot of P-CFY, A-CFY, Co-CFY, and Co-NCFY; and FIG. 4E illustrates capacitance retention of the Co-NCFY after 8250 cycles. Insets are the first four cycles and cycle numbers 8203-8206 at 20 A g⁻¹. Also, FIG. 4F illustrates a schematic of the assembled all-solid-state structural supercapacitor device and LED powered by structural supercapacitor devices, and FIG. 4G illustrates a close-up perspective view of the assembled all-solid-state structural supercapacitor device.

FIG. 5A illustrates extracted apparent strength, apparent modulus, and strain-to-failure from and FIG. 5B illustrates true stress-strain curves of P-CFY, A-CFY, Co-CFY, and Co-NCFY.

FIG. 6A illustrates the b-value for Co-CFY and FIG. 6B illustrates the b-value for Co-NCFY. FIG. 6C is a Nyquist plot of P-CFY, A-CFY, Co-CFY and Co-NCFY supercapacitors (the inset is the equivalent circuit). FIG. 6D illustrates capacity contribution from fast and slow kinetic processes vs. scan rate for Co-NCFY.

FIGS. 7A-7C illustrate extracted apparent strength, apparent modulus, and strain-to-failure from true stress-strain curves of pristine, activated, Co₃O₄ decorated, and N-doped Co₃O₄ decorated carbon nanofiber yarns.

FIGS. 8A-8E illustrate Raman spectra for Co 2p peak of A-CFY, the O 1s peak of P-CFY, A-CFY, Co-CFY, and Co-NCFY, respectively.

FIGS. 9A-9B illustrate CVs of P-CFY at different scan rates of 1, 2, 5, 10, 25, 50, 75, 100, and 200 mV s⁻¹. FIG. 9C illustrates galvanostatic charge/discharge curves of P-CFY at different current densities of 1, 2, 5, 10, and 20 A g⁻¹.

FIGS. 10A-10B illustrate CVs of A-CFY at different scan rates of 1, 2, 5, 10, 25, 50, 75, 100, and 200 mV s⁻¹. FIG. 10C illustrates galvanostatic charge/discharge curves of A-CFY at different current densities of 1, 2, 5, 10, and 20 A g⁻¹.

FIGS. 11A-11B illustrate CVs of Co-CFY at different scan rates of 1, 2, 5, 10, 25, 50, 75, 100, and 200 mV s⁻¹. FIG. 11C illustrates galvanostatic charge/discharge curves of Co-CFY at different current densities of 1, 2, 5, 10, and 20 A g⁻¹.

FIG. 12A-12B illustrates CVs of Co-NCFY at different scan rates of 1, 2, 5, 10, 25, 50, 75, 100, and 200 mV s⁻¹. FIG. 12C illustrates galvanostatic charge/discharge curves of Co-NCFY at different current densities of 1, 2, 5, 10, and 20 A.

FIGS. 13A-13D illustrate true stress-strain curves of pristine, activated, Co₃O₄ decorated, and N-doped Co₃O₄ decorated CFY, respectively.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

The ability to simultaneously carry load and store electrochemical energy in so-called structural energy storage materials (or structural electrodes) makes them a great package for applications in which weight and/or volume is a premium. The structural electrodes can be used as main load bearing components or as a means to reduce the packaging requirements in energy storage devices. The packaging used in electronic devices for conventional energy storage devices like different ion-batteries and supercapacitors adds unnecessary weight and volume to the system, and restricts the form factor to particular cells such as cylindrical shapes. The primary challenge to manufacture an efficient structural electrode is to tune the microstructure such that both performance criteria are adequately met without major sacrifices in each. Carbon-based materials (e.g., carbon nanofibers (CNFs), graphene, etc.) have been used as promising materials for structural electrodes. Among different carbonaceous materials, there have been great efforts to produce free-standing graphene paper as structural electrode but several challenges limit its performance. Among the most prominent challenge has been the reduction in the available surface area of graphene paper due to the restacking of individual graphene sheets. To address this challenge, guest materials such as polyaniline, CNTs, carbon black, and the like were laid between the graphene sheets. The introduction of the second phase has led to other changes such as reduction in either mechanical or electrochemical properties. Despite such tradeoffs, few promising cases with suitable combinations of electrochemical and mechanical properties have been demonstrated. Examples include reduced graphene oxide (RGO)/MnO₂ composite paper (electrochemical capacitance of 897 mF/cm², tensile strength of 8.79 MPa and Young's modulus of 9.84 GPa), graphene/polyaniline composite paper (electrode capacitance of 233 F g⁻¹, tensile strength of 12.6 MPa), graphene-cellulose composite paper electrode (capacitance of 81 mF/cm², and RGO/aramid nanofiber composite (specific capacitance of 226 F g⁻¹ and tensile strength of 106 MPa, Young's modulus of 13 GPa).

While G/GO are in particulate form and require a binder to serve as energy storage materials and also to carry load, continuous reinforcement/electrode materials such as carbon nanofibers (CNF) have also been proposed for structural electrodes. The CNFs are fabricated via pyrolysis, similar to carbon fibers (CF). Due to considerably higher specific surface area than CFs, excellent electrical conductivity and structural stability, continuous carbon nanofibers have attracted attention for use in structural supercapacitors.

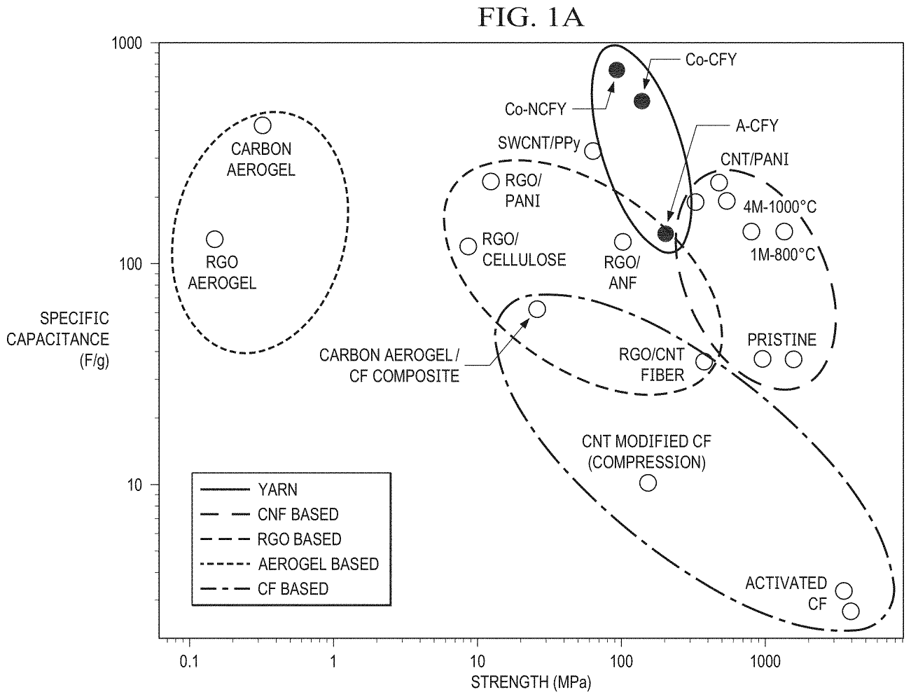

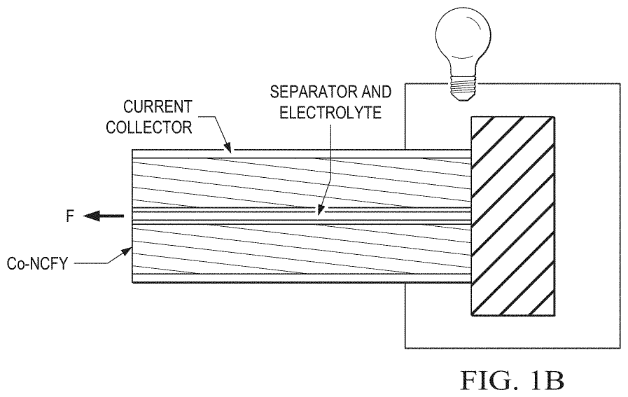

Different kinds of electrospun CNFs, ranging from porous activated CNFs to hollow CNFs have been explored, and the reported capacitance is often in the range of ˜150-400 F g⁻¹. In a recent study, hollow carbon nanofibers with energy storage (191.3 F g⁻¹) were synthesized. Despite the excellent mechanical properties of activated CNFs, the energy storage was solely via electrical double-layer capacitance (EDLC). In fact, this mechanism is the one largely explored in the literature for structural supercapacitors. Hence, the magnitude of energy storage reported is not promising, as shown in the Ashby chart in FIG. 1A. To further enhance the energy storage, one needs to take advantage of the pseudocapacitance mechanism, which can be achieved by embedding early transition metal oxides into the electrodes.

Early transition metal oxides (e.g., Co₃O₄, NiO, MnO₂, and V₂O₅) have shown promising electrochemical properties with remarkable electrochemical attributes, significantly higher than those of carbon-based electrodes. They can be used to build powerful pseudocapacitors as a replacement for particulate two-dimensional (2D) materials (e.g., graphene and MXene family, or toxic RuO₂). The metal oxides-based pseudocapacitors present significantly greater specific energy (energy density) than that of the EDLCs counterpart due to the reversible Faradaic reactions on the active electrode surface.

Among several transition metal oxides, cobalt oxide is an ideal candidate due to offering considerably higher theoretical capacitance of 3560 F g⁻¹, well-defined redox activities, and eco-friendliness. Cobalt oxide seems a great candidate for coating (decorating) or embedding in the CNFs body, which not only stores electrochemical energy but also serves as the main load bearing element. On the other hand, experimentally measured specific capacitances for Co₃O₄ are smaller than the theoretical values, caused by poor electronic integrity/conductivity of Co₃O₄, and subsequently the limitation-imposed on the transfer of electrons. Hence, establishing good bonds between Co₃O₄ and CNFs electrodes is of importance for the material to serve as energy storage device with both EDLC and pseudocapacitance mechanisms.

The present disclosure is aimed at overcoming the above limitations and challenges to manufacture strong and efficient structural electrodes by developing novel carbon nanofiber yarns. Various types of CNF yarns (CFY), including, but not limited to, porous, hollow CNF yarns (P-CFY), activated highly-porous, hollow CNF yarns (A-CFY), ultrafine Co₃O₄-coated highly-porous, hollow carbon nanofiber yarns (Co-CFY), and ultrafine Co₃O₄-coated highly-porous, hollow, N-doped carbon nanofiber yarns (Co-NCFY) have been studied. The present disclosure proposes and demonstrates, for the first time, a multifunctional structural supercapacitor which outperforms recently reported structural electrode materials, by considering both parameters: electrochemical capacitance and tensile strength. The superb mechanical properties of hollow CNF yarns with the outstanding pseudocapacitance properties of Co₃O₄ were combined to fabricate a strong and efficient supercapacitor electrode. Instead of embedding Co₃O₄ into the CNFs' skeleton which can alter the load transfer from one CNF to another, covalent decoration was employed to experience minimum manipulation in the architecture of the CNF mat.

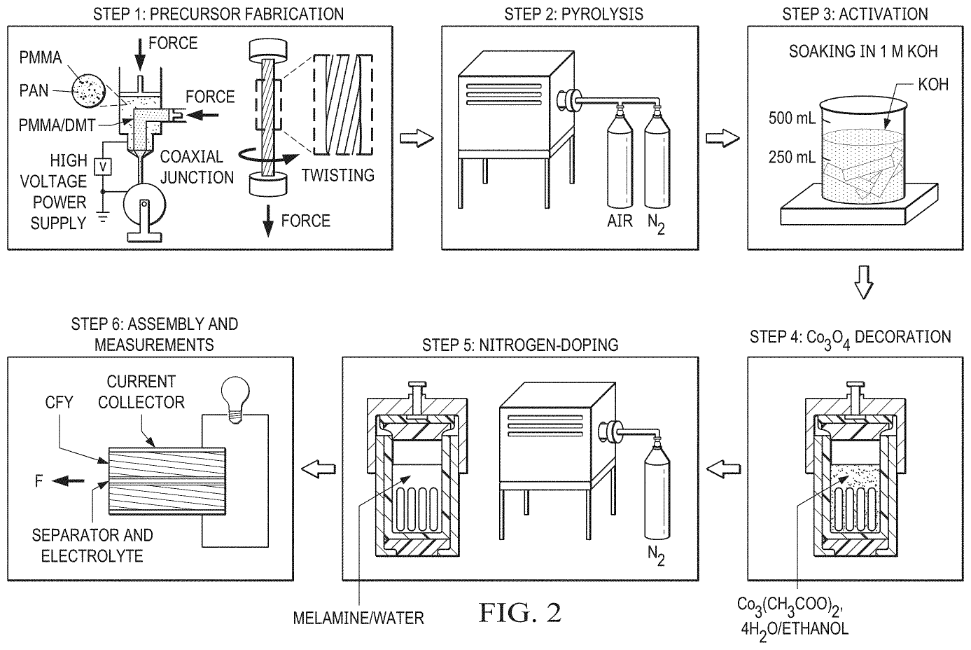

Nitrogen-doping procedure and KOH activation of CNF yarns (CFY) were performed to increase electrical integrity and wettability. Basically, it improves the electrochemical attributes of CNFs with modification of the bandgap through the introduction of heteroatom dopants. All-solid-state symmetric Co-NCFY supercapacitors were prepared and exhibited capacitance of 713 F g⁻¹ at 1 mV s⁻¹, desirable cycling stability of >92% at 20 A g⁻¹ after >8000 cycles, energy density of 45.4 Wh kg⁻¹ at a power density of 209 W kg⁻¹, and high-power density of 5000 W kg⁻¹ at an energy density of 21 Wh kg⁻¹. The capacitance retention for Co-NCFY was >92% after 8000 cycles at 20 A g⁻¹, respectively. Furthermore, both Co-CFY and Co-NCFY showed excellent mechanical properties. FIG. 2 schematically shows the procedure for the fabrication of Co-NCFY.

Reference will now be made to more specific embodiments of the present disclosure and data that provides support for such embodiments. However, it should be noted that the disclosure below is for illustrative purposes only and is not intended to limit the scope of the claimed subject matter in any way.

Four types of CNF yarns were fabricated to evaluate the effect of metal oxides on mechanical and energy storage of the devices: (i) P-CFY, (ii) A-CFY, (iii) Co-CFY, and (iv) Co-NCFY. The fabrication process of the yarns is described below. Sample types i, ii and iii will be respectively used as the basis to fabricate sample types ii, iii and iv.

Fabrication of porous, hollow CNF yarns (P-CFY): This sample serves as a reference sample and as the basis for the following sample types. To fabricate the hollow and porous CNF yarns, the following steps were performed: coaxial electrospinning of polymeric precursors, cutting, and twisting of polymeric fibrous mats, stabilization, carbonization, activation, decoration with Co₃O₄, and nitrogen-doping. A coaxial electrospinning setup with a 21-gauge inner needle and a 12-gauge outer needle was used to fabricate the polymer precursor fibers. Required mass of poly(methyl methacrylate) (PMMA) with average M_{w} ˜350,000 was mixed with Dimethylformamide (DMF) with a purity of ≥99% and sonicated for 30 min at room temperature to prepare a homogenous solution with PMMA concentration of 16 wt. %. This solution was pumped to the inner needle as the core material. The Polyacrylonitrile (PAN)/PMMA/DMF emulsion was injected to the outer needle. The emulsion for the shell was fabricated through sonication of PAN (9.1 wt. %) with average M_{w} —150,000 and PMMA (9.1 wt. %) with average M_{w} ˜15,000 in DMF for 30 min into an ice bath.

Coaxial electrospinning was conducted at a shell flow rate of 0.98 ml hr⁻¹ and a core flow rate of 0.7 ml hr⁻¹, 15 kV voltage, temperature of 27±1° C., relative humidity of 45±5%, and a distance of 20 cm. A grounded rotating drum covered by Cu or Al foil of 5 cm wide was used to collect the fibers at 500 rpm (3.9 m s⁻¹). After 60±5 minutes of electrospinning, the mat was peeled off from the foil on the drum collector and cut into ribbons with width of 4 mm and length of 15 cm. The cut ribbons were subjected to a normal load of ˜50 N and twisted at 300 turns per meter (TPM) for 45 s. They were subsequently stabilized in a convection oven at 270° C. for 2 hrs under air atmosphere, and carbonized in a tube furnace (MTI GSL-1700X) at 1000° C. for 1 hr under nitrogen atmosphere. The yarn at this stage was referred to as pristine carbon nanofiber yarns (P-CFY).

Fabrication of activated highly-porous, hollow CNF yarns (A-CFY): To activate the CNF yarns, the as-prepared P-CFY were soaked in 1M KOH aqueous solution for 3 hrs at room temperature and subsequently dried in a vacuum oven at 70° C. for 12 hrs. The as-prepared yarns were transferred into a tube oven and heated to 1000° C. for 30 min under nitrogen atmosphere. The products of this stage, which are activated carbon nanofiber yarns (A-CFY), were obtained by washing with deionized water (DI) and dried in a vacuum oven at 70° C. for 12 hrs.

Fabrication of ultrafine Co₃O₄-coated highly-porous, hollow carbon nanofiber yarns (Co-CFY): To prepare the Co₃O₄ decorated A-CFY yarns (Co-CFY), 8 mg cobalt (II) acetate tetrahydrate (Co(CH₃COO)₂.4H₂O, >98%, Sigma-Aldrich) was sonicated in 64 mL ethanol for ˜5 min. After synthesis of a light purple solution, it was poured into a 100 ml Teflon stainless steel autoclave reactor. The as-prepared A-CFY was transferred into the autoclave reactor, sealed, and placed in an oven to treat hydrothermally at 150° C. for 3 hrs. The Co-CFY were allowed to cool at room temperature, taken out, placed on a stainless-steel grid, and rinsed with ethanol and DI water. The yarns were again transferred to an oven to anneal at 120° C. for 10 hrs under vacuum and then at 250° C. for 3 hrs under air atmosphere.

Fabrication of ultrafine Co₃O₄-coated highly-porous, hollow, N-doped carbon nanofiber yarns (Co-NCFY): To fabricate the Co-NCFY, the Co-CFY were transferred into a 100 ml Teflon/stainless steel autoclave reactor filled with aqueous melamine solution of 0.02 mg ml⁻¹ melamine, sealed, and placed in an oven to treat hydrothermally at 150° C. for 3 hrs. The sample subsequently was taken out and dried in an oven at 70° C. for 12 hrs. The as-prepared yarns were transferred to an alumina crucible, placed in a tube furnace and heated with a ramping rate of 5° C. min⁻¹ to 500° C. and kept at 500° C. for 1 hr under nitrogen atmosphere.

Fabrication of symmetric all-solid-state supercapacitors. To assemble a symmetric supercapacitor, first a piece of Cu foil is covered by a thin layer of conductive paste and four CFYs aligned in parallel with the length of ˜3 cm were attached on it. The second electrode/current collector was prepared by the same method. Then, the current collector with the attached CNFs was coated with a layer of PVAH₂SO₄ gel electrolyte and dried at an oven at 40° C. The gel electrolyte solution was synthesized through stirring 1 gr PVA (average Mw˜98,000, Sigma Aldrich), 3 ml H₂SO₄ (Sigma Aldrich) and 10 ml DI-water at 85° C. After a fully transparent solution without any non-reacted PVA was achieved, it was coated onto the electrodes. After solidification of the gel electrolyte, the assembled multi-layered symmetrical supercapacitor was punched and transferred to a gold-coated split-able test cell (EQ-HSTC split-able test cell) for electrochemical measurements. The mass of active electrode was 4.0 mg, 3.2 mg, 6.2 mg and 2.9 mg for the P-CNY, A-CFY, Co-CFY, and Co-NCFYs, respectively.

Electrochemical characterization: To measure the electrochemical properties of the electrodes, two techniques were used: cyclic voltammetry (CV) and galvanostatic charge discharge (GCD). A CH Instrument 700B Bipotentiostat was utilized for measuring the specific capacitance (CV and GCD) of the yarns. A CH Instrument 604E Bipotentiostat was used to obtain the electrochemical impedance spectroscopy (EIS). In CV technique, the specific capacitance (Csp) was obtained as:

$${C}_{sp} = \frac{1}{2 k \cdot m ( {V}_{2} - {V}_{1} )} ∮ I ( V ) dV \qquad Equation ( 1 )$$

I(V), k, m, and V₂-V₁ are the current of the CV loop, the scan rate with the unit of V s⁻¹, the mass of active material (g), and the scanning potential window, respectively. The integral term in the numerator represents the area of the I-V curve. In the GCD test, Cₛₚ was calculated as:

$${C}_{sp} = \frac{I \cdot Δ t}{m \cdot Δ V} \qquad Equation ( 2 )$$

I, Δt, and ΔV are the discharge current (A), discharge time (s), and discharge potential window, respectively. For non-linear discharge curve, Cₛₚ was obtained by:

$${C}_{sp} = \frac{2 I \cdot A}{m \cdot Δ {V}^{2}} \qquad Equation ( 3 )$$

A is the area below the discharge curve. The E and power density (P) of the symmetric supercapacitor were respectively obtained by:

E=(1/7.2M)Cₛₚ(ΔV)²(Wh kg⁻¹) Equation (4)

P=3600.ElΔt(W kg⁻¹) Equation (5)

M is the total mass of the active electrodes.

Mechanical characterization: Microtest 200 tensile module (Gatan) with a load cell of 20 N was used for measuring the mechanical properties of the yarns. The measurements were performed at least three times with a crosshead velocity of 0.1-0.2 mm min⁻¹.

Microstructure characterization: SEM/EDS images were obtained by an ultra-high resolution FE-SEM (JEOL JSM-7500F) at 2-5 kV for capturing images and 20 kV for EDS. High-Resolution Transmission Electron Microscopy (HRTEM) samples were prepared by sonicating a small piece of Co-CFY and Co-NCFY into ethanol for ˜5 min and then drop-casting on lacey carbon grids. The TEM/HRTEM images were obtained by JEOL JEM-2010 TEM and FEI Tecnai G2 F20 St FE-TEM. To collect XPS results, an Omicron XPS/UPS system with an Mg Ka 1253.6 eV excitation source at X-ray power of 150-300 W was used. The XPS data analyzing was performed by the CaseXPS package with curve-fitting standard deviation of less than 1% for all the samples. A Horiba Jobin-Yvon LabRam HR confocal Raman system was used for chemical and molecular characterization.

Results and discussion: The morphologies of the four different types of CFY electrodes were examined using low-resolution and high-resolution FESEM. The outer diameter of the CNF yarns according to the low-resolution FESEM images is 125±10 μm. The surface morphology of the individual CNFs after each phase of the study was analyzed via high-resolution FESEM. The surfaces of P-CFY and A-CFY are relatively smooth. Similar to recent studies, pit and dent density increases on the fiber surfaces after KOH activation.

The cross-section surfaces of the constitutive fibers showed mesopores with regular circular shape. These mesopores in the shell are formed by the decomposition of PMMA islands during the carbonization step.

While the high-resolution FESEM images of P-CFY and A-CFY show smooth surfaces with no deposited particles, the Co-CFY and Co-NCFY have distinctly rough morphology, and coated with a thin layer of nanoparticles. By following the procedure indicated in the experimental section, the Co₃O₄ nanoparticles are deposited on the A-CFYs. N-doping does not have a major impact on the surface morphology of CFYs.

In an earlier study, energy dispersive spectroscopy (EDS) of P-CFY and A-CFY revealed the presence of carbon (C), oxygen (O), and a low concentration of nitrogen (N). In addition to the C, O and N, the EDS elemental distribution maps confirm the presence of cobalt (Co) in the as-prepared Co-CFY and Co-NCFY. Moreover, compared to the P-, A-, and Co-CFY with small percentage of N relative to other elements (originating from the nitrile groups in the PAN polymer), the Co-NCFY shows a dramatic rise in N concentration, implying the success of N-doping. Furthermore, the EDS elemental mapping and line mapping of the as-prepared Co-NCFY illustrate the uniform distribution of elements Co and N on all CNFs.

Consistent with the high resolution FESEM images, the A-CFY includes mesopores with smooth boundaries. The high resolution TEM image also demonstrates that the interlayer spacing of turbostratic domain of carbon fibers in A-CFY is 0.42±0.00 nm, which is slightly larger than non-treated carbon fibers (0.38 nm). The greater interlayer spacing is attributed to the intercalation of the K ions during activation step at high temperatures.

The deposition of a thin layer of Co₃O₄ nanoparticles was further confirmed by the TEM images and selected-area electron diffraction (SAED) pattern. For Co-NCFY, the outer and inner surfaces, as well as any hole/channels in main fibers' skeleton with the possibility of transferring Co ion were covered by Co₃O₄ nanoparticles in a way that the hollow section of the fiber is not distinguishable from the side image. The high resolution TEM images further reveal the interatomic distance of 0.431±0.009 nm and 0.249±0.008 nm, corresponding to the interlayer spacing of turbostratic domain of carbon fibers and the (311) plane of the face-centered-cubic phase of Co₃O₄. The polycrystalline structure of the decorated nanoparticles on Co-NCFY is further verified by the selected area electron diffraction (SAED) pattern. The concentric diffraction rings can be associated with the (311), (400), (422), and (511) planes of Co₃O₄ from the inside to the outside, demonstrating the high crystallinity of the decorated Co₃O₄ nanoparticles.

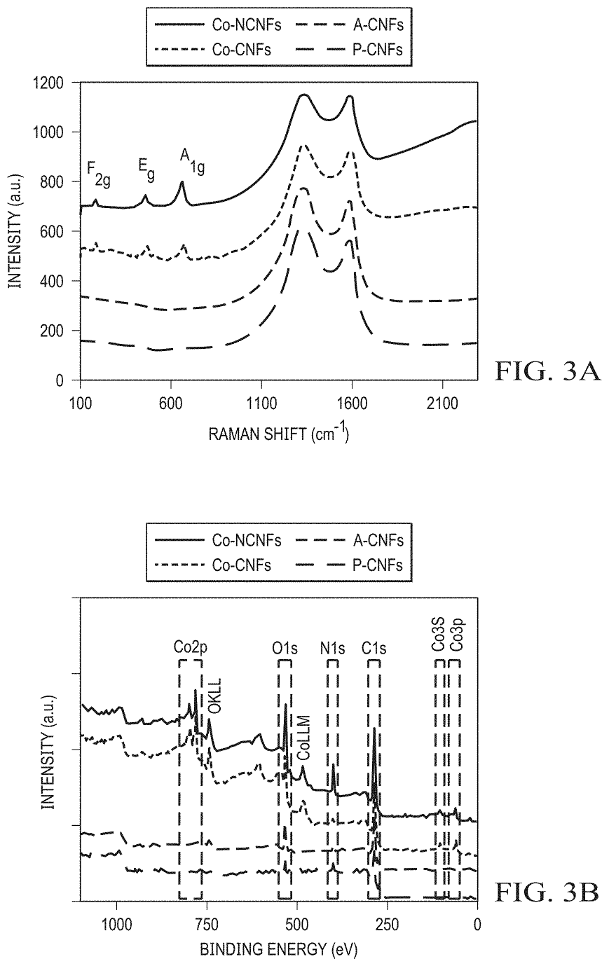

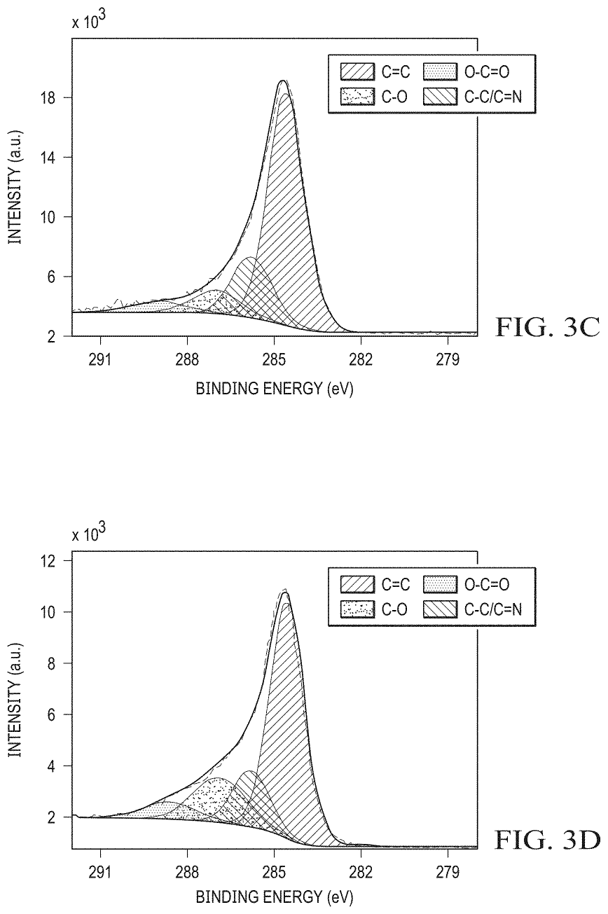

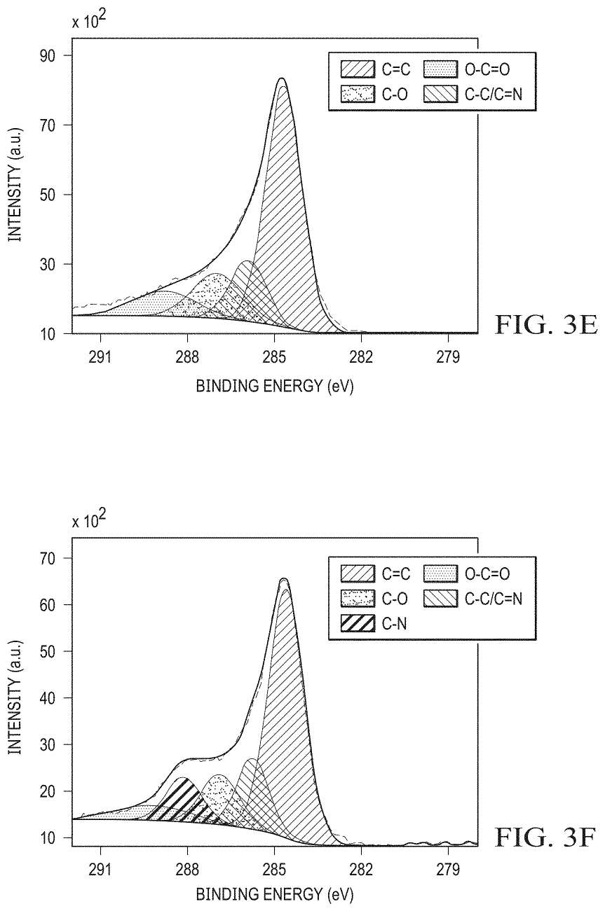

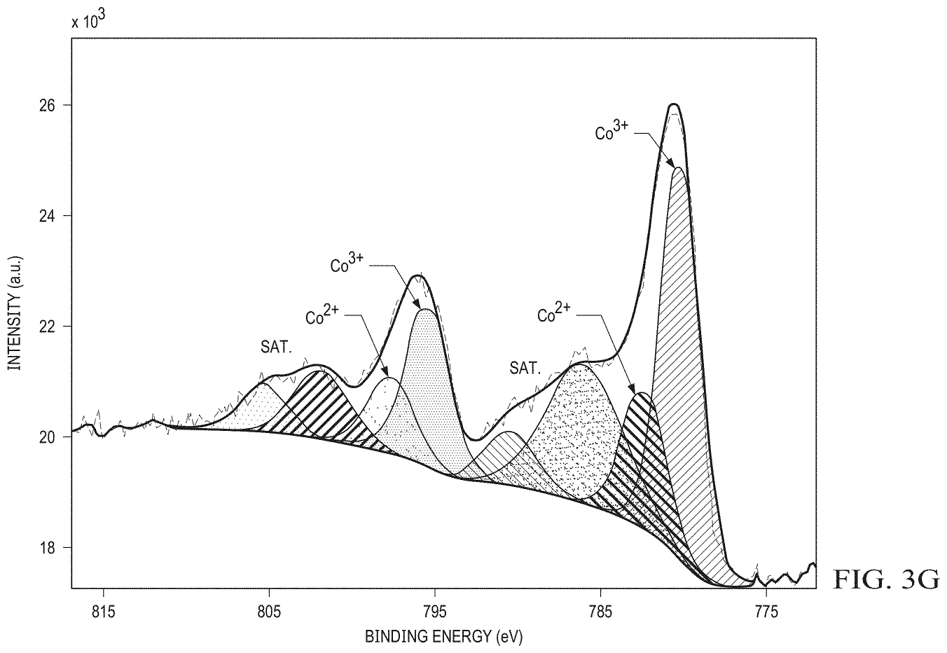

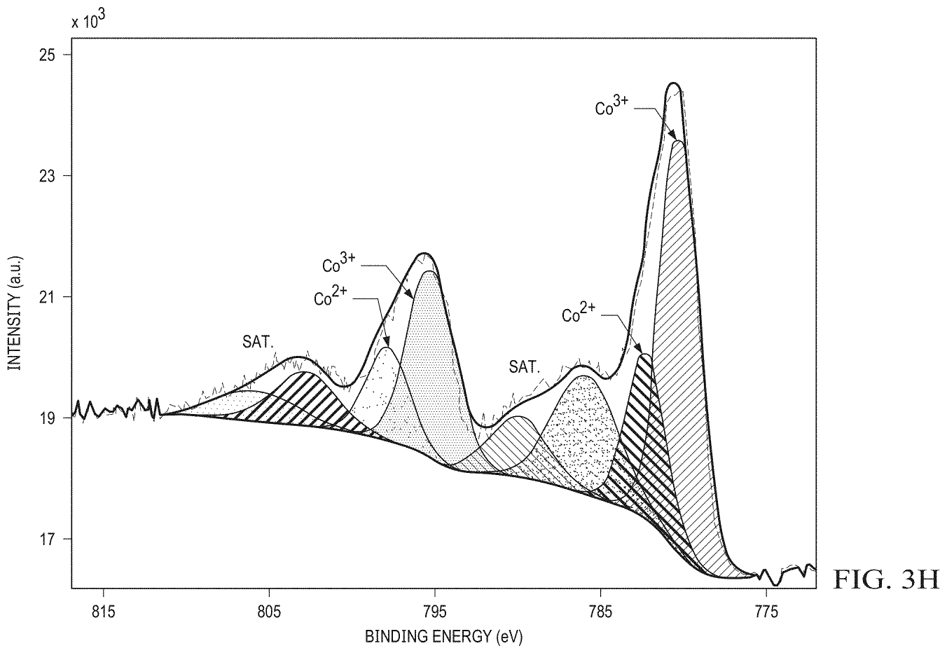

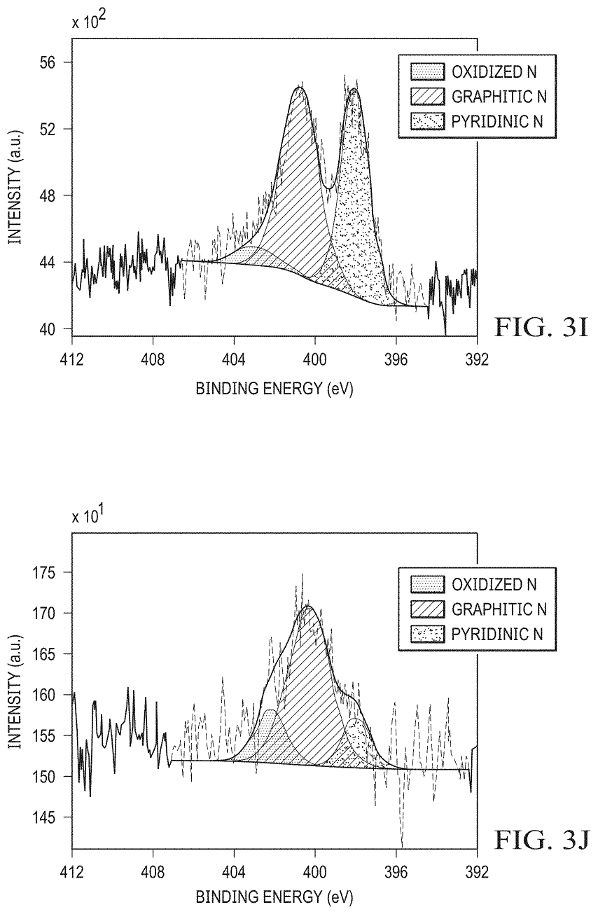

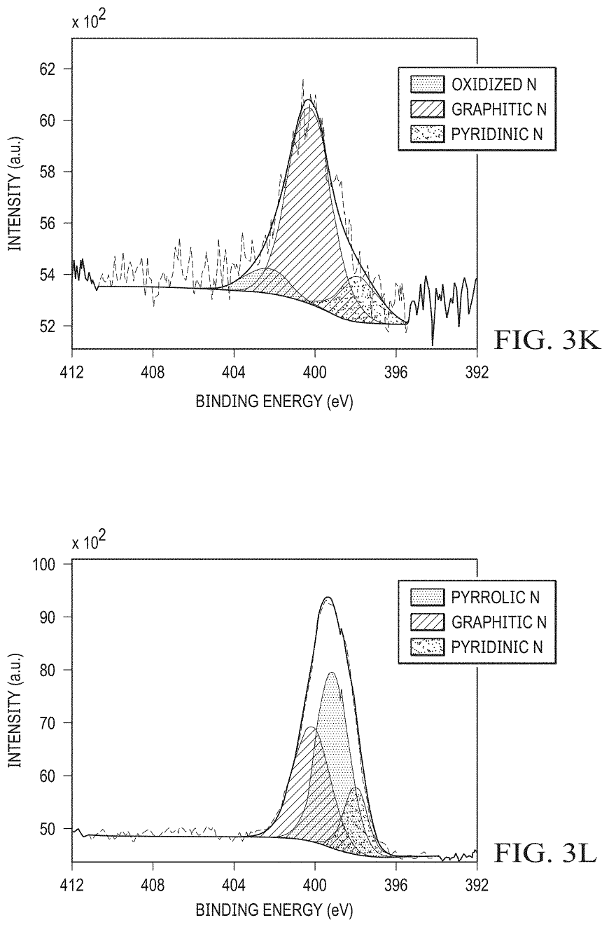

Raman spectra of P-CFY, A-CFY, Co-CFY, and Co-NCFY are presented in FIG. 3A. All four samples had two prominent bands at ˜1579 and ˜1334 cm⁻¹, assigned to the graphitic (G) and disorder (D) bands, respectively. The I_{D}/I_{G} for all the samples was nearly the same, signifying no comparative losses in the graphitic structure of the CFY after activation, N-doping, and Cobalt oxide decoration processes. However, after the decoration of the CNFs with metal oxide (with and without N-doping), a redshift of D peak by about 6 cm⁻¹, and F_{2g}, E_{g}, and A_{1g} bands are observed respectively at 191, 475, and 678 cm⁻¹, which are indexed to Raman-active modes of the crystal Co₃O₄. While the Raman spectrum of Co-NCFY shows the same peaks as Co-CFY, the sharpening of the peaks in Co-NCY is an indicator for changing the surface electronic structure after annealing/N-doping.

To trace the changes in the compositions of the samples, X-ray photoelectron spectroscopy (XPS) was used. As shown in the survey XPS spectra (FIG. 3B), the P-CFY and A-CFY have the elements of carbon, oxygen, and nitrogen signals, and the XPS spectra of both Co-CFY and Co-NCFY present cobalt signals as well (e.g., Co 2p peak at ˜780 eV and Co 3p at ˜61 eV). The chemical composition for all the samples is shown in Table 1.

TABLE 1
Chemical composition of samples evaluated by XPS.

| | C | N | O | Co |
|---|---|---|---|---|
| Sample | (at %) | (at %) | (at %) | (at %) |
| P-CNFs | 89.1 | 4 | 6.9 | 0.0 |
| A-CNFs | 82.4 | 2.5 | 15.1 | 0.0 |
| Co-CNFs | 72.5 | 2.6 | 20.2 | 4.7 |
| Co-NCNFs | 67.7 | 10.8 | 16.9 | 4.6 |

The activation step caused an increase in the oxygen content from 6.9 at % in the P-CFY to 15.1 at % in the A-CFY and a reduction in the nitrogen content from 4 at % to 2.5 at %. The main difference between the Co-CFY and Co-NCFY is the nitrogen content, which increased from 2.6 at % in the Co-CFY to 10.8 at % in the Co-NCFY.

FIGS. 3C-3L show the high-resolution XPS spectra of the samples. FIGS. 3C-3F show the deconvoluted C 1 s spectra for the P-CFY, A-CFY, Co-CFY, and Co-NCFY, respectively. The deconvoluted C 1s spectra of the P-CFY, A-CFY, Co-CFY present four common peaks at ˜284.6 eV, 285.8 eV, 287 eV, and 288.8, representing the C═C, C—C/C═N, C—O, and O—C═O groups, respectively. After the activation step, the percentages of C—O and O—C═O functional groups increased. This is due to the formation of oxygen-containing functional groups through a reaction between KOH and carbon elements in the CNF yarns.

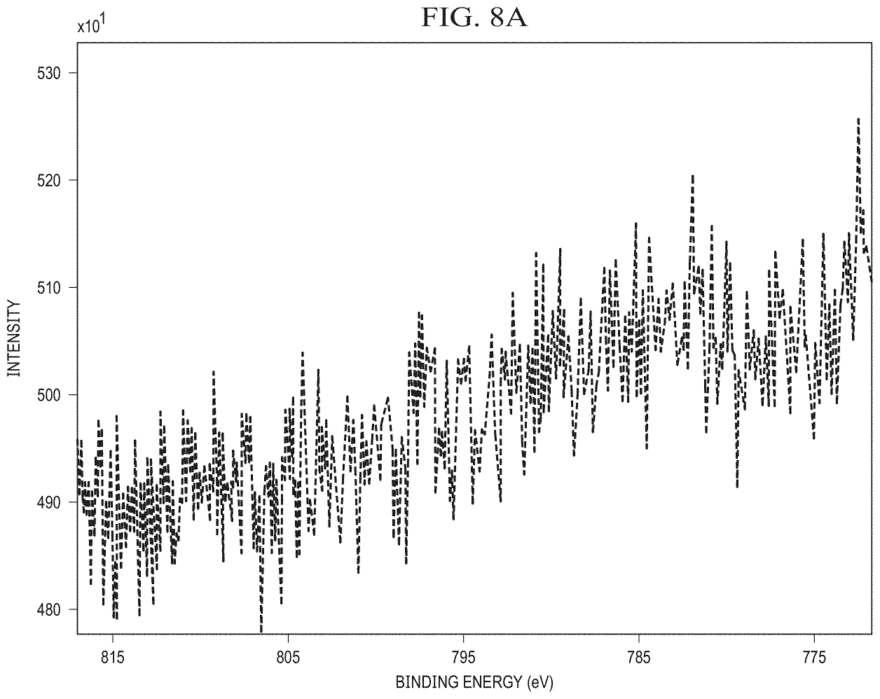

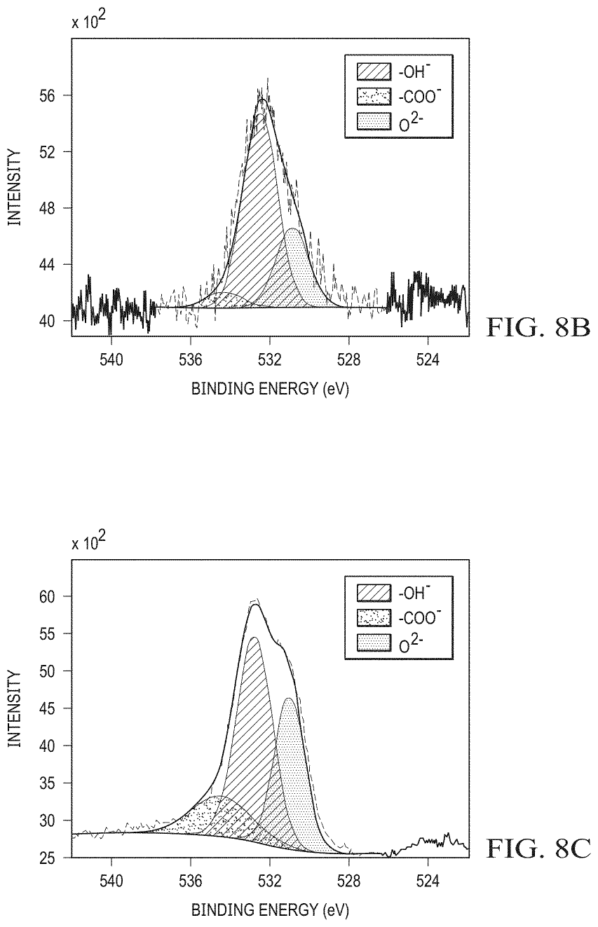

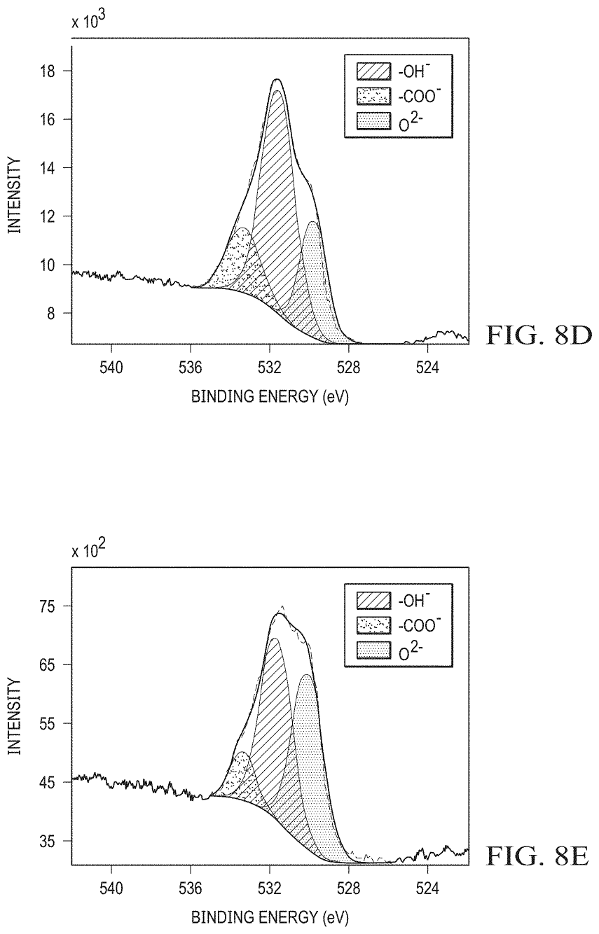

The assigned peak to carboxylate anion at 288.8 eV sharpens after Co-decoration, which can be caused by ionic interactions between carboxylate anion and trivalent cobalt cation. After the N-doping procedure, a new peak at 288.1 eV was raised, which can be assigned to the C—N group. While the P-CFY and A-CFY show no bond associated with Co element (FIG. 8A), the Co 2p XPS spectra of both Co-CFY and Co-NCFY (FIG. 3G and FIG. 3H, respectively) are identical and comprised of Co 2p_{1/2} and Co 2p_{3/2} spin-orbit split components. Furthermore, the 2p_{1/2} and 2p_{3/2} spin-orbit split components of both samples can be fitted with four pairs of Gaussian-Lorentzian curves (FIGS. 3G-3H). The Co 2p_{1/2} and Co 2p_{3/2} spin-orbit split components possess the same chemical information. For both Co-CFY and Co-NCFY samples, each pair component consists of four pairs of distinguishable components, which are at 780.1 (795.5) eV, 782.3 (797.7) eV, 786.0 (801.7) eV, and 790.5 (805.3) eV for 2p_{3/2} (the values in brackets belong to 2p_{1/2}), which can be assigned to Co³⁺, Co²⁺, 1^{st} satellite, and 2^{nd} satellite peaks for Co₃O₄, respectively. From the XPS results, it can be concluded that N-doping has no effect on the chemical composition of the Co₃O₄, while it changes the chemical composition of the fibers. Also, the reaction may start with nucleation of the Co(OH)₂ on the CF substrate and continue with the transformation of Co(OH)₂ nanocrystals gradually into Co₃O₄ in the subsequent heat treatment procedure. The carboxylate anions on the surface of the A-CFY played a role as surfactants to form the Co₃O₄. The results are in good agreement with the Raman results.

FIGS. 3I-3L show the N is XPS spectra of the samples. The N is XPS spectrum of P-CFY (FIG. 3I) is fitted with three peaks at 398 eV, 400.7 eV, and 402.8 eV, attributed to pyridinic N, graphitic N, and oxidized N bonds. After activation, the intensity of pyridinic N on the surface reduces and the oxidized N increases (FIG. 3J), which is caused by the intense oxidizing behavior of KOH agent at >700° C. The Co-decoration has no effect on the chemical configurations of N-dopants. In addition to a significant increase in the N content and different configurations of N-dopants, the N-doping leads to the formation of a strong pyrrolic N bond at 399.0 eV, in agreement with C 1s XPS spectrum of the Co-NCFY. Sharpening of the peaks in the Raman spectrum after the N-doping is caused by the changing of the surface electronic structure of CFY after N-doping.

The O 1s XPS spectra of the samples, FIGS. 8B-8E, shows three peaks at 530.0 eV, 531.6 eV, and 533.3 eV, attributed to the oxygen in O²⁻, OH⁻, and COO⁻ terminal groups, respectively. The reaction of P-CFY with KOH groups and the oxidation/activation process can be verified by comparing the high-resolution O 1s XPS spectra for P-CFY and A-CFY, where all the oxygen-containing bonds intensify. Upon the CFY decoration with Co, all oxygen components increase. Of which, the dominant rise is for the OH⁻ peak as shown in FIG. 8D, which is due to the initiation of Co(OH)₂. The last annealing procedure during the N-doping leads to the partial transformation of Co(OH)₂ nanocrystals into Co₃O₄ and in situ reduction of the CF skeleton.

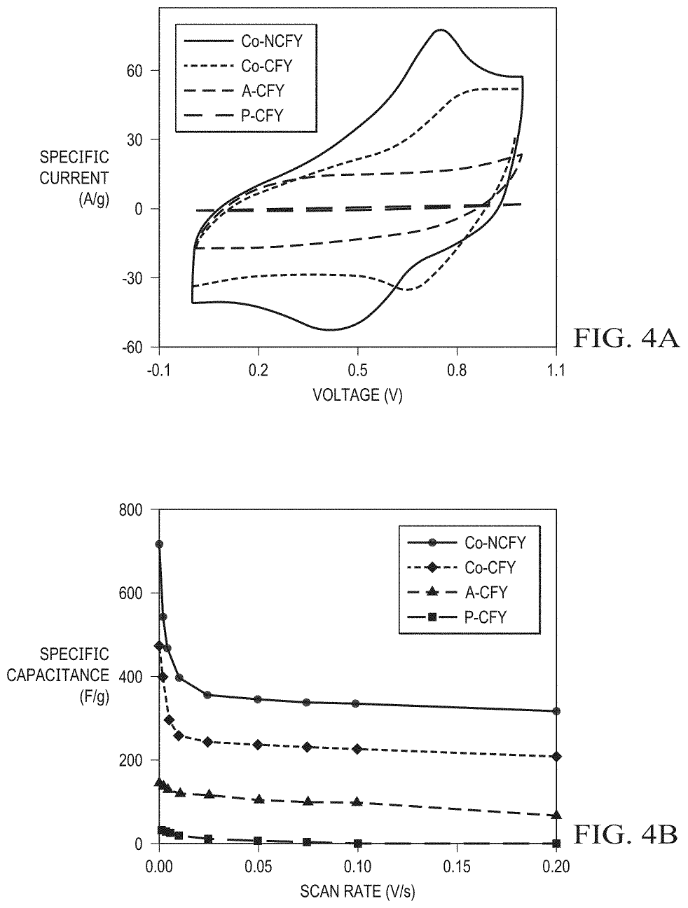

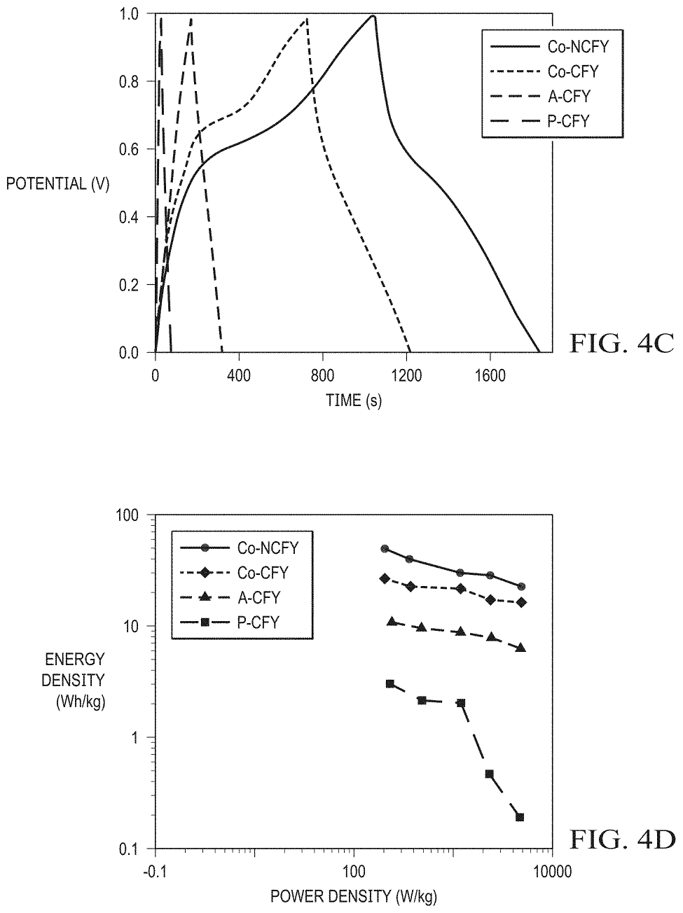

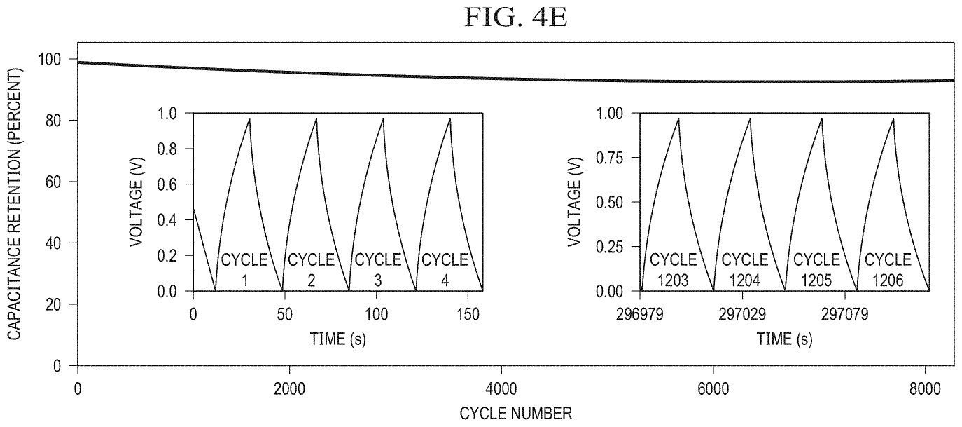

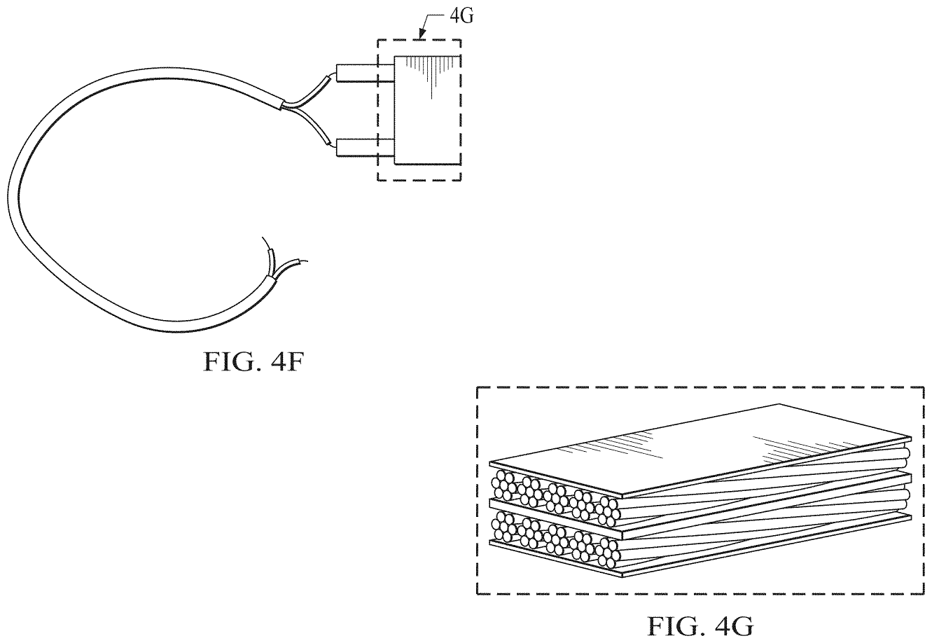

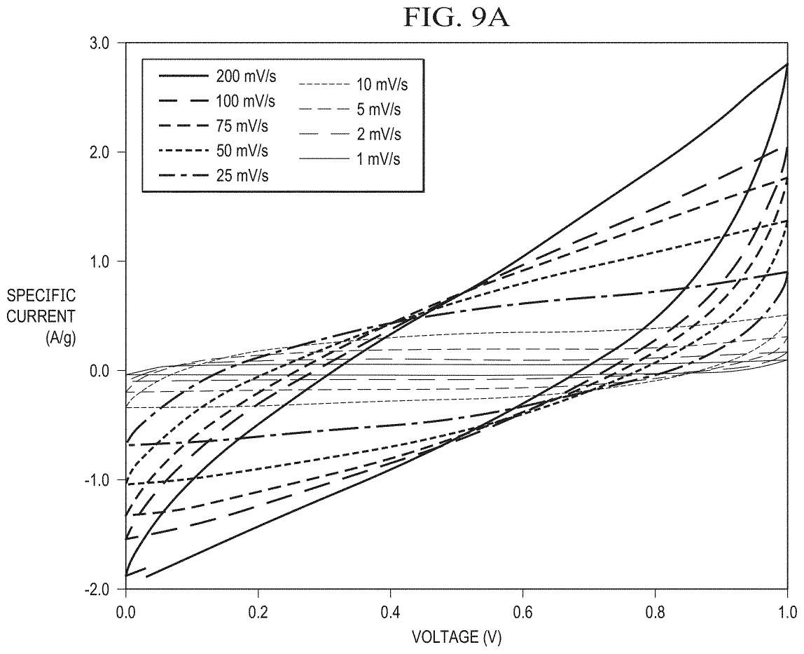

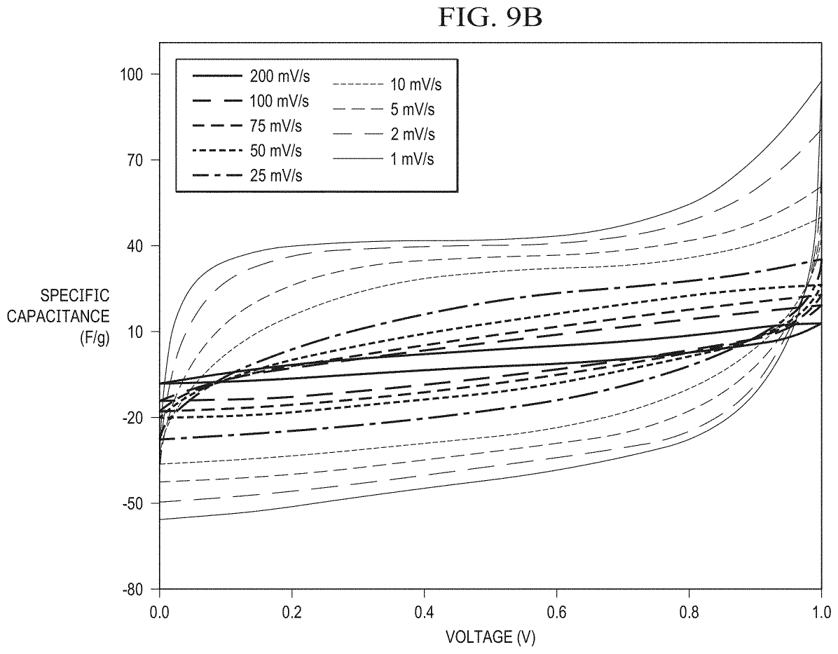

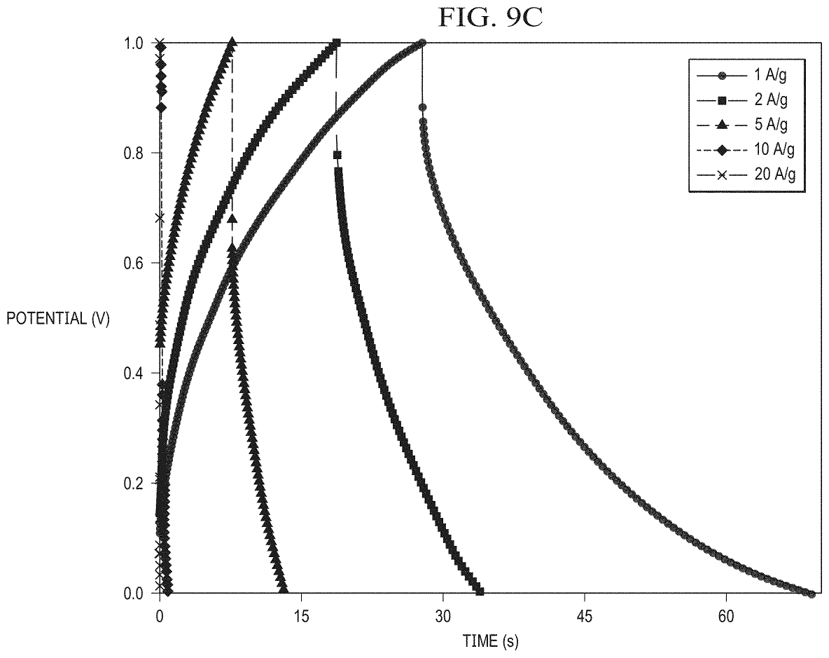

Electrochemical measurements: The energy storage capability of P-CFY, A-CFY, Co-CFY, and Co-NCFY are evaluated by CV and GCD in a symmetric two electrode system using 3M H₂SO₄/PVA gel electrolyte. The CV curves for all the samples are measured at different scan rates from 1 mV s⁻¹ to 200 mV s⁻¹ (FIGS. 9A-9B, FIGS. 10A-10B, FIGS. 11A-11B, and FIG. 12A-12B. To readily compare the performance of different CNF yarns, FIG. 4A demonstrates the CVs for different CFY samples at a scan rate of 100 mV s⁻¹. The P-CFY electrode shows a rather poor response, demanding activation with 1M KOH to enhance the performance. Upon subjecting electrodes to the activation step, the CV curves for A-CFY become closely rectangular, demonstrating an electrostatic double layer capacitive behavior. On the other hand, the Co-CFY electrode shows the CV plots with the redox peaks, indicating the major pseudocapacitance contribution of the decorated Co₃O₄. FIG. 4B shows that the specific capacitance of all the samples reduces with increasing scan rate. For all the CFY samples, the largest specific capacitance obtained at 1 mV s⁻¹ is 37.5 F g⁻¹ (P-CFY), 153.6 F g⁻¹ (A-CFY), 471.7 F g⁻¹ (Co-CFY), and 713.9 F g⁻¹ (Co-NCFY). The higher capacitance of Co-NCFY than that of Co-CFY are principally due to pseudocapacitance of N-dopants and elevated electric conductivity. the electron-donating N and electron-rich O doping bring significant pseudocapacitance contribution. Contribution of these elements also enhances the wettability of carbon-based structure and the accessible active surface for electrolyte ions. In addition, the combined effect of N and O heteroatoms can provide more electro-active sites, and significantly boosts the overall electrochemical behaviors.

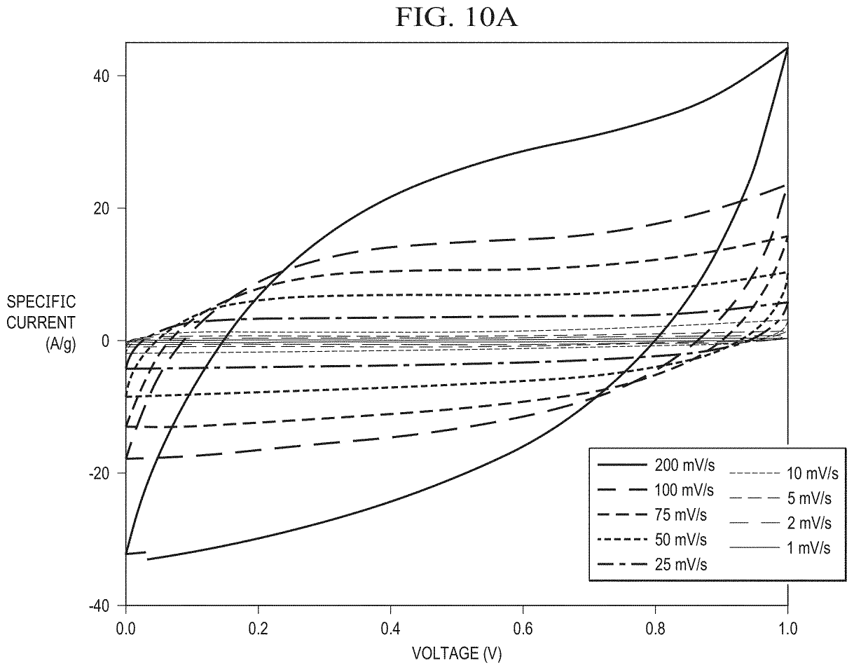

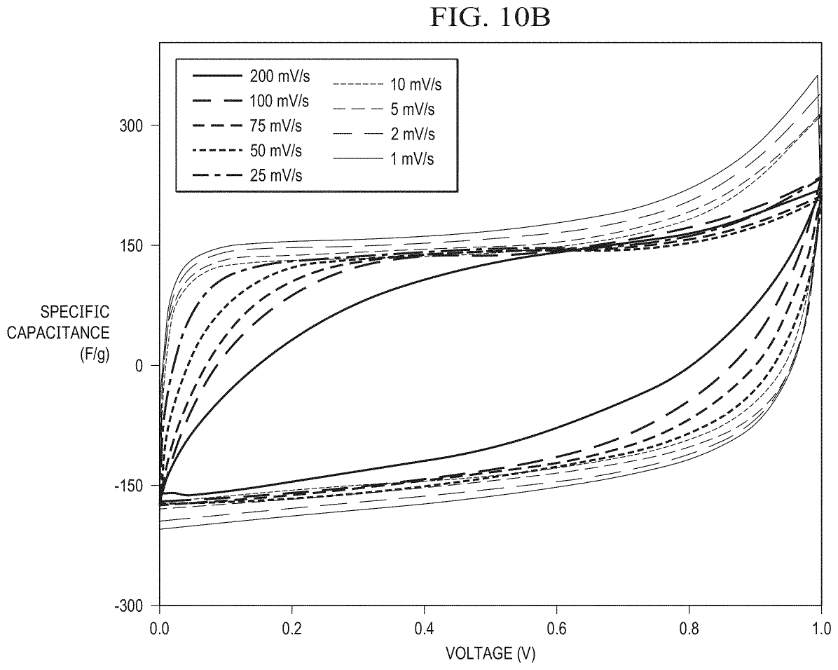

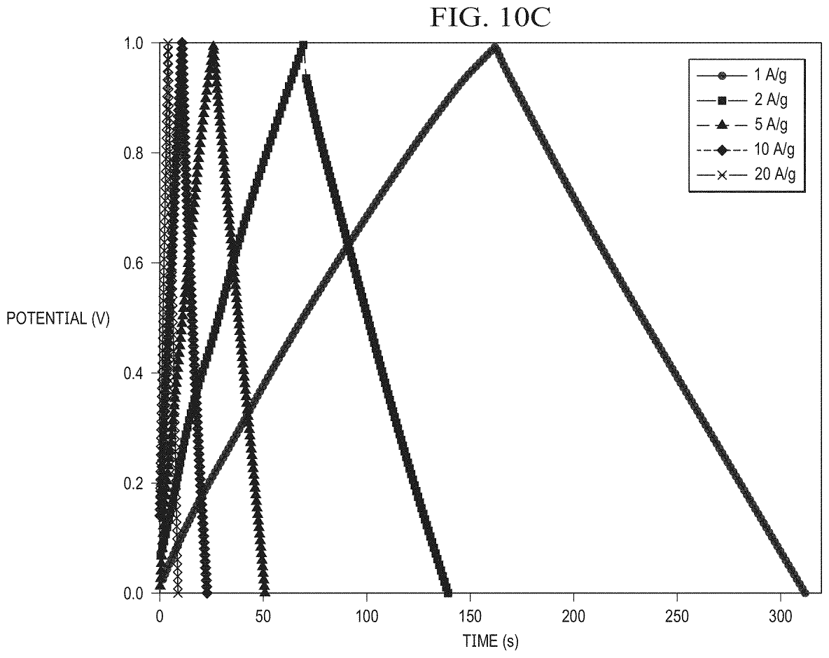

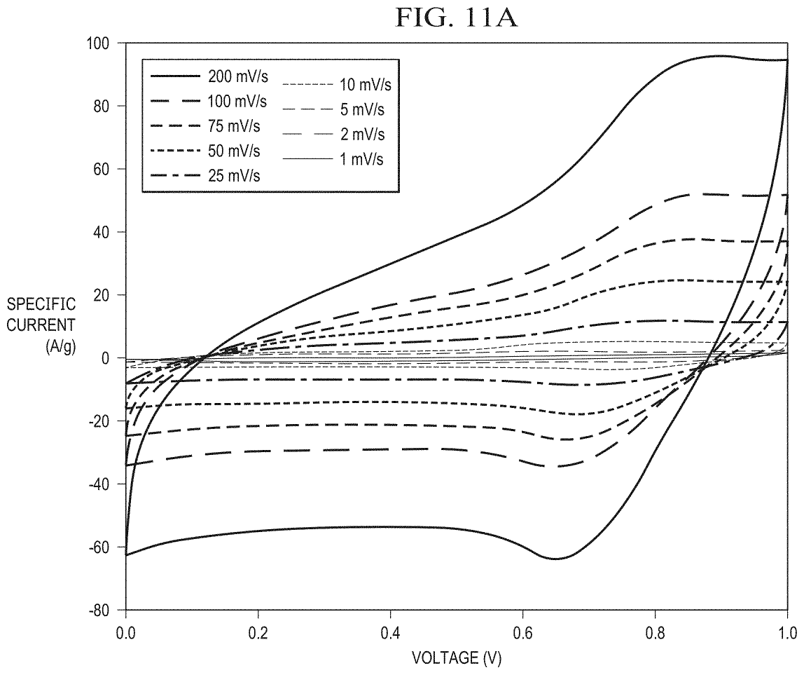

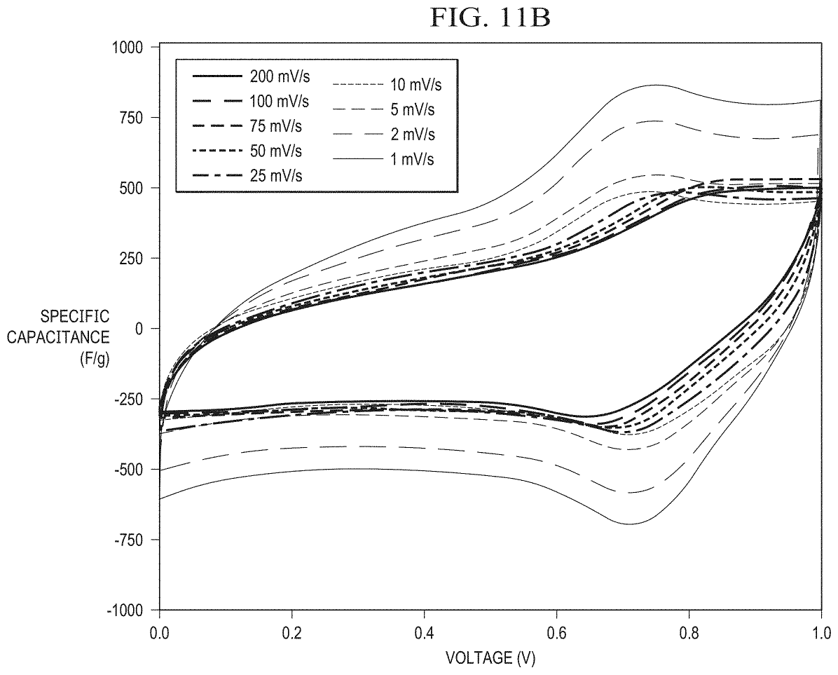

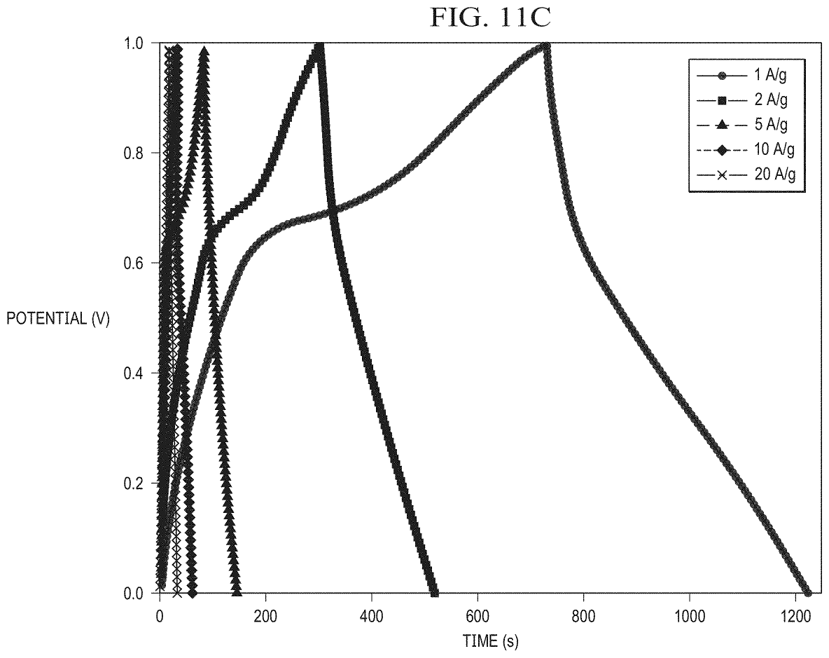

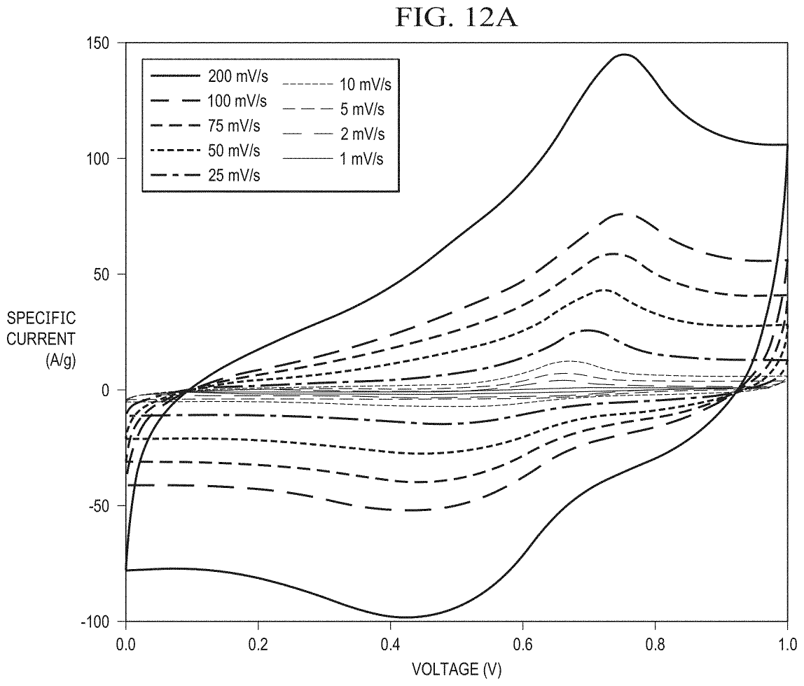

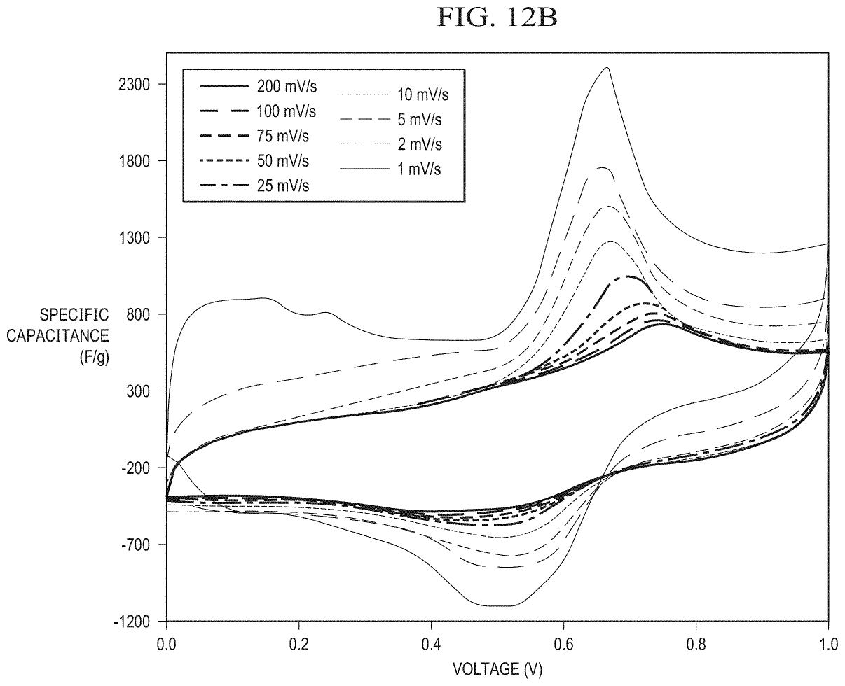

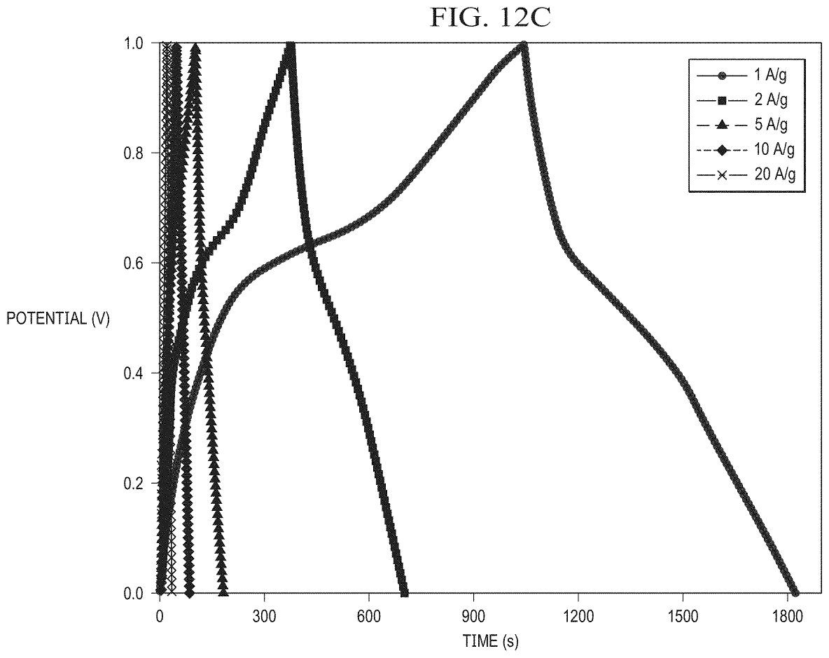

The capacitive behavior was also measured by the GCD method, as shown in FIG. 4C and FIG. 9C, FIG. 10C, FIG. 11C, and FIG. 12C. After activation, all the charging/discharging plots feature triangular shapes with insignificant internal resistance at the beginning of the discharge curve. The decoration of Co₃O₄ on the CFY makes all the charging/discharging plots nonlinear, which is due to the extra pseudocapacitance contribution of Co₃O₄. It is worthy to note that the GCD curves of Co-CFY and Co-NCFY electrodes (FIG. 11C and FIG. 12C) are symmetric at various current densities tested, which indicates that both Co-CFY and Co-NCFY have a promising reversibility throughout the charge-discharge process. As compared to Co-CFY, Co-NCFY clearly presented longer discharge time at the same current density (FIG. 4C), further supporting the importance of N-doping for increasing the electrical conductivity integrity through the heteroatom doping and enhancing surface wettability. The specific capacitance of Co-NCFY is 653 F g⁻¹ at 1 A g⁻¹, much higher than several studies on the non-structural Co₃O₄-based electrodes (see Table 2 below). The voltage drop (IR drop) at the onset of the discharge curve remains small after surface decoration with Co and N-doping at different current densities, which is evidence for low equivalent series resistance (ESR) of the test cells operated with Co-CFY or Co-NCFY.

TABLE 2
Capacitive performance of various Co₃O₄-based electrodes at 1 A g⁻¹

| | Specific | |
|---|---|---|
| Types of materials | capacitance | Capacitance retention |
| Core-Shell Nitrogen-Doped | 581 F g⁻¹ | 95.2 after 5000 cycles |
| Carbon Hollow Spheres/Co₃O₄ | | |
| Nanosheets | | |
| Homogeneous Co₃O₄/N- | 616 F g⁻¹ | 93.6% after 5000 cycles |
| doped carbon aerogel | | |
| Co₃O₄/activated honeycomb- | 456 F g⁻¹ | 91% after 2000 cycles |
| like carbon | | |
| Co₃O₄@hollow-carbon-fiber | 566.9 F g⁻¹ | |
| Co₃O₄ | 568.8 F g⁻¹ | 95.6% after 500 cycles |
| microspheres/Graphene | | |
| Co₃O₄-Encapsulated Carbon | 586 F g⁻¹ | 74% after 2000 cycles |
| nanofibers | | |
| Co₃O₄ nanosheets/N-doped | 451 F g⁻¹ | 95% after 1000 cycles |
| Graphene foam | | |
| 3D Co₃O₄ twin-spheres | 754 F g⁻¹ | 97.8% after 1000 cycles |
| SWCNT/Co₃O₄ nanoflakes | 313.9 F g⁻¹ at | 80% after 3000 cycles |
| | 1 mV s⁻¹ | |
| Co₃O₄ microspheres | 298.8 F g⁻¹ | 94.5% after 10,000 cycles |
| Co₃O₄-decorated porous, | 653 F g⁻¹ | 92% % after 8,000 cycles |
| hollow, N-doped Carbon | | |
| Nanofibers Yarn | | |

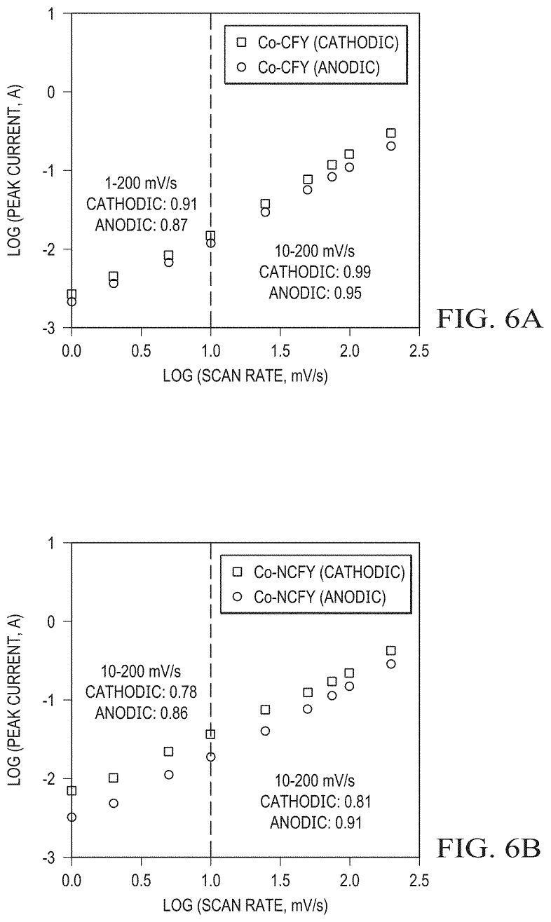

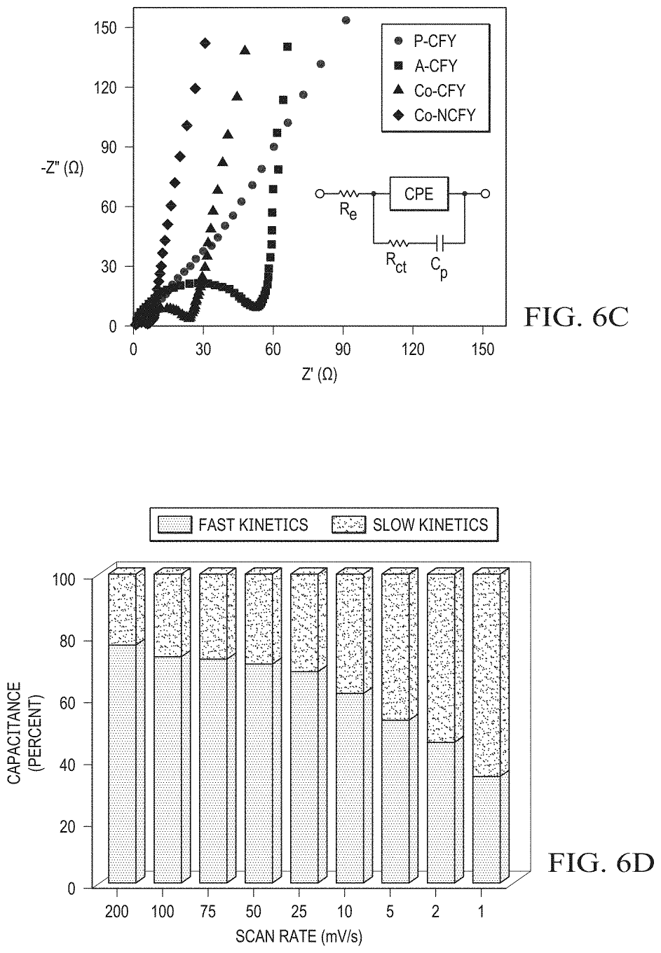

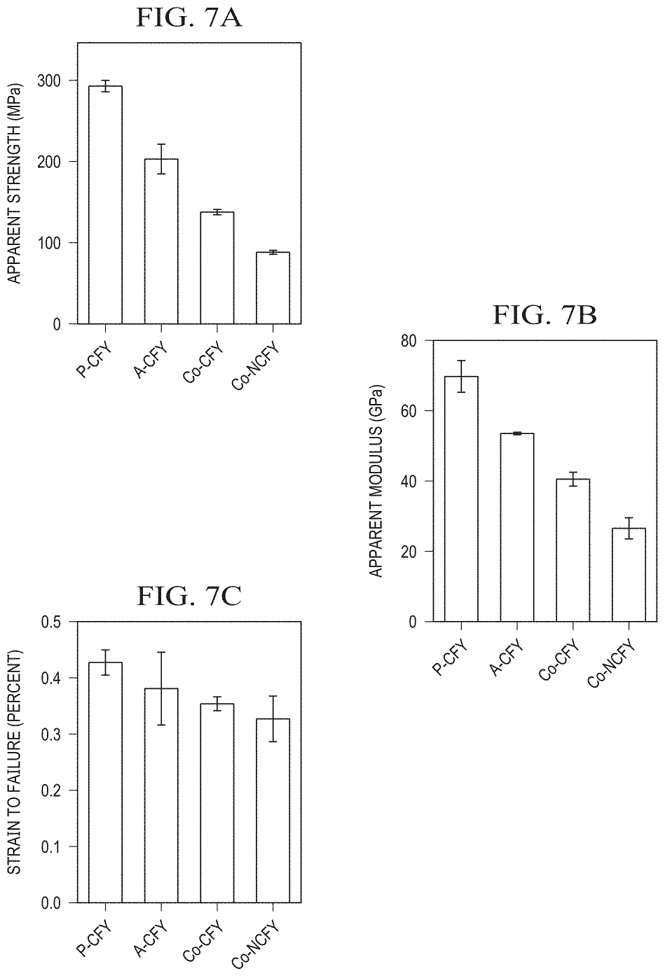

A peak shift and an increase in peak separation are obvious in FIGS. 11 and 12. Thus, it is essential to determine the charge storage mechanism for both Co-CFY and CO-NCFY. To this end, for both cathodic and anodic peaks, a plot of the logarithm of the peak current (i) versus the logarithm of the scan rate (v) is presented in FIG. 6A for Co-CFY and FIG. 6B for Co-NCFY. For a capacitive process, the current and scan rate can be related by a power-law relationship, which is: i=avb. The value of b is an indicator of the charge storage mechanism, where b≈0.5 and 1 are associated with semi-infinite linear diffusion (often considered for batteries which include ion intercalation) and surface-controlled mechanisms (for supercapacitors), respectively. The obtained b-value for Co-CFY (FIG. 6A) is ˜1 at scan rates of 1-200 mV s⁻¹, indicating the dominance of surface-controlled kinetics. After N-doping (FIG. 6B), the slope of both the cathodic and anodic peaks drops, resulting to a value of b in the range of 0.78-0.90 (the lower value in the range corresponds to slower reaction kinetics). The b-value for all the electrode materials, in particular in scan rates >10 mV s⁻¹ (as shown in FIG. 6), clearly demonstrates that the charge storage obeys the pseudo-capacitance mechanism even at peak currents. The EIS analysis was also employed to investigate the ion diffusion/transport resistance for the fabricated symmetric supercapacitors. The impedance of the different CFY supercapacitors was obtained in the frequency range of 200 kHz-0.01 Hz at open circuit potential (FIG. 6C). The impedance spectra were similar for A-CFY, Co-CFY and Co-NCFY, forming an arc at a higher frequency region and a spike at lower frequency. The A-CFY and Co-CFY show a small electrolyte resistance (Rₑ) of 0.4 Ω, lower than that of Co-NCFY with Rₑ of 0.7 Ω It can be due to the higher ratio of 0/N content of A-CFY. Co-NCFY shows the smallest semicircle radius compared with the counterparts, implying the least charge-transfer resistance (R_{ct}). The low R_{ct} designates efficient electron transport participated in the redox reactions of Co₃O₄ and heteroatoms. It should be noted that small R_{ct} is beneficial in collection of charge from the external circuit as well as in reduction of the interface charge loss. For Co-NCFY, the Cₚ at the electrical equivalent circuit (FIG. 6C, inset) represents the pseudocapacitive element due to the redox process of CO₃O₄. The CPE signifies a constant phase element caused by the double-layer capacitance of CFY. As a key parameter, the capacity contribution from fast and slow kinetic processes of the Co-NCFY are also calculated and presented in FIG. 6D. As exhibited in FIG. 6D, as the scan rate increases, the slow capacitance contribution decreases, while the fast capacitance remains unchanged at 245 F g⁻¹.

Power density (P) and energy density (E) are parameters for evaluating the overall performance of an electrochemical cell. FIG. 4D shows the Ragone plots for P-CFY, A-CFY, Co-CFY, and Co-NCFY devices, which were obtained from galvanostatic discharge curves. A maximum E of 45.4 Wh kg⁻¹ at power density of 209 W kg⁻¹ for Co-NCFY is obtained, while the largest P is 5000 W kg⁻¹ at the energy density of 21.5 Wh kg⁻¹ with the working voltage window of 1 V. These values are remarkable, compared to the reported structural energy storage materials reported in the literature. These include, the majority Co₃O₄-based electrochemical electrodes, such as Co₃O₄/N-doped carbon hollow spheres with maximum E of 34.5 Wh kg⁻¹ at P of 753 W kg⁻¹, CO₃O₄/hollow carbon fiber/Activated Carbon hybrid with maximum E of 24.3 Wh kg⁻¹ at P of 750 W kg⁻¹, and Co₃O₄/N-doped carbon aerogel with maximum E of 33.43 Wh kg⁻¹ at P of 375 W kg⁻¹. This enhancement is due to the excellent contributions of the base material (CNFs via EDLC), the remarkable pseudocapacitance contribution of the decorated Co₃O₄, good electrical integrity and excellent wettability.

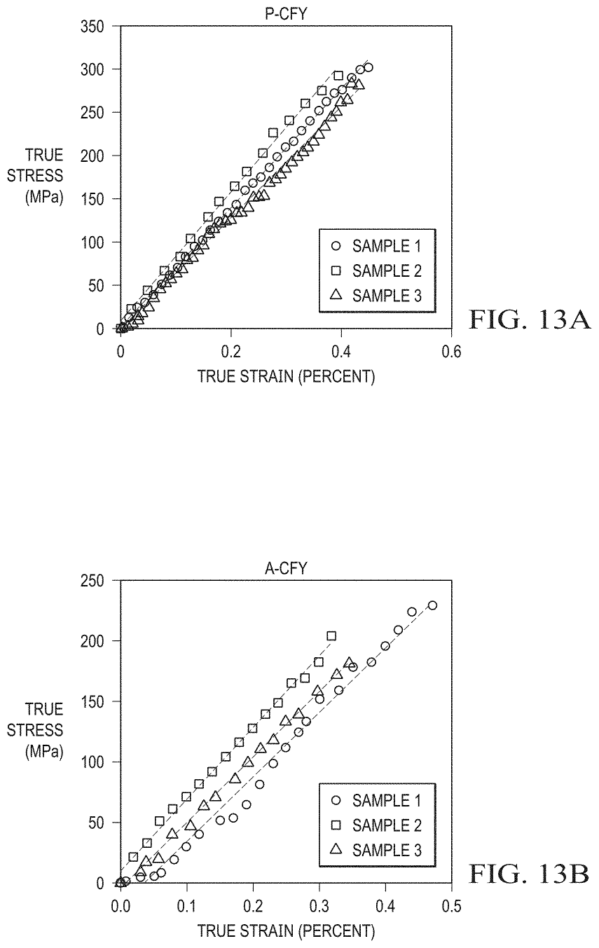

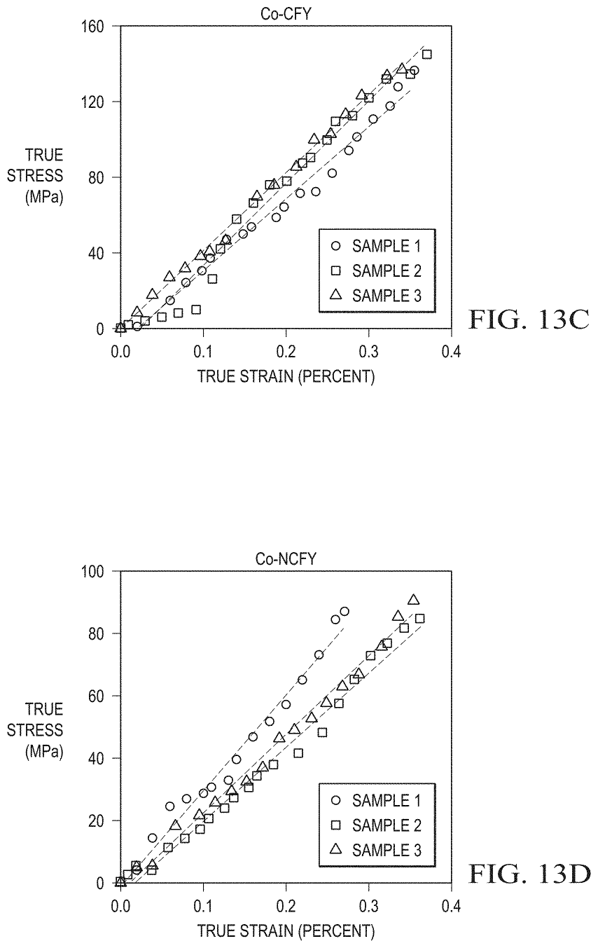

The GCD technique was also used to measure the electrochemical stability of the Co-NCFY, as shown in FIG. 4E. The Co-NCFY was subjected to cyclic GCD at a current density of 20 A g⁻¹ over >8000 cycles. The Co-NCFY structural electrode retained >92% of its initial specific capacity after >8000 cycles. The insets of FIG. 4E and FIG. 13 show the GCD curves of the structural Co-NCFY at different cycles, showing its remarkable electrochemical stability and reversibility degree. FIG. 4F shows a schematic of the structural supercapacitor and its layers and an image of the fabricated supercapacitor unit, which was used to light a light-emitting diode (LED) after charging.

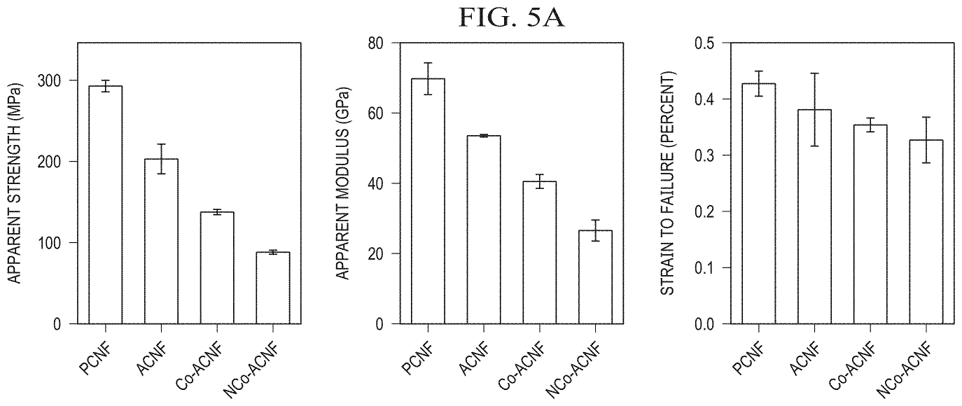

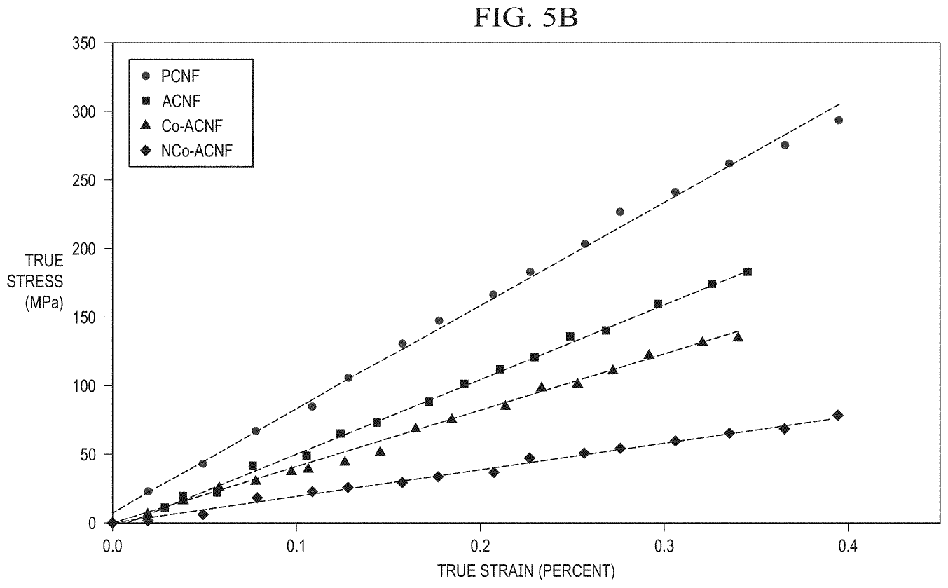

Mechanical characterization: The overall performance of the structural supercapacitors demands satisfactory load bearing capabilities. Therefore, the mechanical properties of the fabricated P-CFY, A-CFY, Co-CFY, and Co-NCFY were measured using tensile tests. The experiments were performed at least three times for each case, and the corresponding true stress-strain curves are shown in FIG. 13. The true stress-strain curves were used to extract the relevant properties such as strength, modulus, and strain-to-failure, as depicted in FIGS. 5A-5B. The linear density or mass per unit length was used to calculate the specific stress using Equation 6 below and the true stress was then derived by multiplying the specific stress and density using Equation 7 below.

$${σ}_{s} = \frac{F}{L D} = \frac{Force ( N )}{Linear Density ( g / Km )} \qquad Equation ( 6 )$$

$${σ}_{T} = ρ \times {σ}_{s} = Density \times Specific stress \qquad Equation ( 7 )$$

For all materials, the stress-strain curves followed a linear behavior up to failure indicating brittle fracture. Compared to the P-CFY, the KOH activation, the Co₃O₄ decoration, and the N-doping steps all partially reduced the mechanical properties as seen in FIG. 5A. The maximum drop (relative to the P-CFY) occurred for Co-NCFY where the apparent strength, apparent modulus, and strain to failure decreased by respectively 70%, 62%, and 23% compared with the P-CFY.

The reduction of mechanical properties upon KOH activation can be traced back to the formation of voids. As earlier discussed, the activation step increased the number of surface pores (also potentially the interior pores by the same etching mechanism) as well as specific surface area, compared to P-CFY. Besides, these pores could serve as stress concentrators, which would further reduce the mechanical properties.

Upon the Co decoration, the Co ions may intercalate through the turbostratic domains and the Co₃O₄ crystal formation may induce internal stress (due to lattice mismatch). From the TEM images, an increase in the interlayer spacing of graphitic turbostratic domains, compared with ACFY (internal stress) would further help the slip plane movement, which could slightly reduce the mechanical properties and particularly the mechanical strength. The reduction of mechanical properties by N-doping is expected due to the debonding of adjacent nitrogen and carbon atoms in the loading direction.

FIG. 1A shows the Ashby plot which was developed to compare the specific capacitance and strength of the fabricated yarns in this study with existing structural electrode materials in the literature, such as aerogel-based, graphene-based, CF-based, and CNF-based materials. While the aerogel-based electrodes show superb specific capacitance, they suffer from poor mechanical strength. On the other hand, the CF based materials have excellent mechanical strength but low specific capacitance. The graphene and CNF based materials show an acceptable balance between specific capacitance and mechanical strength, but they are suffering from low electrochemical properties, as compared to most faradic supercapacitors.

The true value of structural energy storage devices and the relative significance of energy storage and load bearing depend on the specific application. Assuming that for a certain application, both functionalities have equal importance, the best materials for the structural electrode are those with the greatest value of material index of Csₛₚ·σ_{f}, where σ_{f} and Cₛₚ are failure strength and specific capacitance, respectively. Materials that best meet the design requirements for structural supercapacitors must lie toward the top right of the Ashby plot (FIG. 1A). Accordingly, both Co-CFY and Co-NCFY outperform all other recently reported materials by plotting the material index. In particular, the N-CFY lies toward the topmost of the plot, representing the best capacitance and ideal mechanical strength, compared to existing materials.

Conclusion: In conclusion, by growing Co₃O₄ nanoparticles on the surface of carbon nanofiber (CNF) yarns and generation of meso- and micropores during KOH activation, materials can benefit from both EDLC and pseudocapacitance mechanisms to store electrochemical energy. The Co-NCFY exhibits a high capacitance of 713 F g⁻¹ at 1 mV s⁻¹ and desirable cycling stability of >92% at 20 A g⁻¹, which is due to possessing numerous electron transfer channels, good electrical integrity, and appropriate bonding/connection between Co₃O₄ and the substrate. Morphological analysis showed an increase in the interlayer spacing in the graphitic domain after activation and Co₃O₄ decoration, indicating the intercalation of K and Co into the turbostratic structure of CNFs. The symmetric all-solid-state Co-NCFY supercapacitor device exhibited energy density of 45.4 Wh kg⁻¹ at a power density of 209 W kg⁻¹. A trade-off between the load-bearing capacity and energy storage, after subjecting to different procedures was traced. The specific capacitance of yarns improved by 1.5×, 4.6×, and 18.9× and their strength decreased by 30%, 53% and 70% after activation, Co₃O₄ decoration, and Co₃O₄ decoration/N-doping steps, respectively. Notably, the Co-NCFY outperforms all reported structural electrode materials (FIG. 1A), with respect to an index that represents both load-bearing and energy storage capabilities. The strategy used herein is an effective way of reducing the size of the supercapacitors for size sensitive applications.

In view of the aforementioned, an aspect of the present disclosure relates to fabrication of ultrafine Co₃O₄-coated highly-porous, hollow, N-doped carbon nanofiber yarns to be used as a high performance multifunctional structural electrode with remarkable mechanical and electrochemical properties. Other methods were introduced before to fabricate carbon nanofibers and fibers with either good mechanical properties or high electrochemical properties, but not both. In contrast, the present disclosure demonstrates that fabricated highly porous carbon nanofiber yarns, even with high density of porosity, can simultaneously carry tensile load and store electrochemical energy. For example, in some embodiments, the nanofiber yarns as disclosed herein are hollow and highly porous with excellent mechanical properties even in the presence of pores. The yarn of the present disclosure constitutes of tightly twisted nanofibers which enable direct load transfer between nanofibers as well as ion exchanges through the electrolyte medium. The twisting procedure described herein contribute to the strength values disclosed herein. So, the present disclosure differs from carbon nanofibers in its fabrication and composition and being a yarn (a twisted fiber) that achieves two positive effects concurrently.

These properties make the yarn of the present disclosure a great package for use as structural electrode in energy storages in which weight and/or volume is a premium. While different types of carbon nanofiber yarns were fabricated with either high mechanical or electrochemical properties, disclosed herein is a type of carbon nanofiber yarn that can be synthesized and can meet both requirements. The carbon fiber yarns contain highly porous hollow fibers with very high surface area. The procedure disclosed herein generally includes coaxial-electrospinning, yarn spinning, activation, metal oxide decoration and N-doping. During the activation process, in addition to increase in the surface area, the surface of the carbon nanofibers is coated by oxygen-containing groups such as —COOH and —C—OH. The metal oxide decoration associated with a covalent bonding between and Co element and oxygen-containing groups and followed by annealing to produce Co₃O₄. During the activation step, the interlayer spacing of turbostratic domain of fiber increases to 0.42 nm. So, Co ions with ionic diameter smaller than of the interlayer spacing of turbostratic domain slip into the gap and react with the active oxygen-containing functional groups to produce cobalt oxide (Co—O—R) and/or Cobalt(III) oxyhydroxide (CoOO—R). A portion of Co oxides oxidizes to the Cobalt(II,III) oxide (Co₃O₄) during annealing.

The electrodes exhibit excellent electrochemical and mechanical properties under tensile load. The targeted structural energy storage device benefits from both the electric double layer and Faradaic reactions to store energy. The structural supercapacitor including ultrafine Co₃O₄-coated highly-porous, hollow, N-doped carbon nanofiber yarns electrodes show remarkable increase in capacitance (713 F/g at 1 mV/s), as compared to CNFs, desirable cycling stability of >92% at 20 A/g after >8000 cycles, the energy density of 45.4 Wh/kg at a power density of 209 W/kg, the tensile strength of 87.4 MPa, and young modulus of 26.4 GPa.

As such, the yarns of the present disclosure could be implemented in structural electronic devices, and weight-sensitive applications such as, but not limited to, ground and air vehicles with electric propulsion. Commonly, the energy storage device and the structural frame are the heaviest components. Naturally, significant weight saving can be achieved by using Co₃O₄-coated highly-porous, hollow, N-doped carbon nanofiber yarns as the structural electrode.

Additionally, in weight-sensitive applications such as ground and air vehicles with electric propulsion, the energy storage device, and the structural frame are usually the heaviest components. Naturally, significant weight saving can be achieved by combining these functionalities through the development of structural energy storage materials. The packaging used in electronic devices for conventional energy storage devices like different ion-batteries and supercapacitors adds unnecessary weight and volume to the system. It also restricts the form factor to particular cells such as, for example, cylindrical shapes. The structural electrodes provided herein possess excellent mechanical and electrochemical properties simultaneously. The present disclosure has established a systematic method to fabricate structural supercapacitor devices to fill the gap, which can be considered as the next generation of condensed energy storage devices with drastically enhanced energy density and mechanical properties.

The present disclosure includes a procedure for fabrication of Co₃O₄-decorated (coated) carbon nanofiber yarns as electrode for structural supercapacitors with remarkable capacitance, long lifetime, good strength, and Young's modulus. In the novel design of energy storage, the procedure to prepare different types of carbon nanofiber yarns is described and explained in detailed herein. This knowledge is highly applicable in developing the next generation of condensed and efficient structural energy storage devices for a wide range of applications, including ground and air vehicles.

As detailed above, the present disclosure proposes and demonstrates a multifunctional structural supercapacitor which outperforms recently reported structural electrode materials, by considering both parameters: electrochemical capacitance and tensile strength. The superb mechanical properties of hollow CNF yarns were combined with the outstanding pseudocapacitance properties of Co₃O₄ to fabricate a strong and efficient supercapacitor electrode. Instead of embedding Co₃O₄ into the CNFs' skeleton which can alter the load transfer from one CNF to another, covalent decoration was employed to experience minimum manipulation in the architecture of the CNF mat. Nitrogen-doping procedure and KOH activation of CNF yarns were performed to increase electrical integrity and wettability.

As demonstrated above, the applied carbon fibers are highly porous. In addition, large numbers of nanopores in highly porous fiber-based yarn are promising reservoirs for storage of ions. The existence of numerous nanopores on the surface results in facile transport channels for ions to the center of yarns even for yarns with higher diameter, while the large surface area can improve rapid charge-transfer reaction and support appropriate electrode/electrolyte interface for absorbing ions even in the presence of solid electrolyte. Furthermore, the interlayer spacing of turbostratic domain of carbon fibers is a little bit greater than previously-manufactured carbon fibers-based yarns, facilitating the ion penetration and improving the electrochemical capacitance by proving higher specific surface area and rates. In fabrication, warm-drawing associated with the twisting step increases the crystalline structure of the final CNFs, which results in an improvement in the electrochemical and mechanical properties.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

What is claimed is:

1. A metal oxide-coated nanofiber yarn comprising:
a plurality of twisted carbon nanofibers,
wherein each twisted carbon nanofiber comprises a porous hollow fiber and metal oxide nanoparticles coated on a surface thereof, and
wherein an outer surface of each twisted carbon nanofiber, an inner surface of each twisted carbon nanofiber, and holes or channels of a main fiber skeleton of the plurality of twisted carbon nanofibers are covered by the metal oxide nanoparticles.

2. The metal oxide-coated nanofiber yarn of claim 1, wherein an interlayer spacing of turbostratic domain of each twisted carbon nanofiber is altered during activation of the plurality of twisted carbon nanofibers.

3. The metal oxide-coated nanofiber yarn of claim 2, wherein the interlayer spacing of turbostratic domain is sized such that the metal ion is smaller than the interlayer spacing of turbostratic domain, and metal oxide can enter into a gap formed on the surface of each twisted carbon nanofiber to react with an active functional group comprising oxygen during decoration of the metal oxide nanoparticles.

4. The metal oxide-coated nanofiber yarn of claim 1, wherein the metal oxide nanoparticles are Co₃O₄ nanoparticles.

5. The metal oxide-coated nanofiber yarn of claim 1, further comprising a solid electrolyte medium disposed between at least two twisted carbon nanofibers.

6. The metal oxide-coated nanofiber yarn of claim 5, wherein the plurality of twisted carbon nanofibers enable ion exchange through the electrolyte medium.

7. The metal oxide-coated nanofiber yarn of claim 1, wherein the plurality of twisted carbon nanofibers enable direct load transfer between each twisted carbon nanofiber to another.

8. The metal oxide-coated nanofiber yarn of claim 1, wherein the plurality of twisted carbon nanofibers are doped with heteroatoms such as Nitrogen.

9. The metal oxide-coated nanofiber yarn of claim 1, wherein the plurality of twisted carbon nanofibers are N-doped.

10. The metal oxide-coated nanofiber yarn of claim 1, wherein each twisted carbon nanofiber simultaneously carries tensile load and stores electro-chemical energy.

11. A method of making a metal oxide-coated nanofiber yarn, the method comprising:
coaxial electrospinning of polymeric precursors;
twisting polymeric fibrous mats formed via the coaxial electrospinning to thereby form a plurality of twisted carbon nanofibers, each twisted carbon nanofiber comprising a porous hollow fiber;
carbonizing the plurality of twisted carbon nanofibers;
activating the plurality of twisted carbon nanofibers;
decorating the plurality of twisted carbon nanofibers with metal oxide nanoparticles; and
doping the plurality of twisted carbon nanofibers with heteroatoms.

12. The method of claim 11, further comprising increasing surface area of each twisted carbon nanofiber during activation.

13. The method of claim 11, further comprising coating each twisted carbon nanofiber with an oxygen function group during activation.

14. The method of claim 13, further comprising covalent bonding of metal elements of the metal oxide nanoparticles during decoration with the oxygen functional groups.

15. The method of claim 11, wherein the metal oxide nanoparticles are Co₃O₄ nanoparticles.

16. The method of claim 11, wherein the doping comprises N-doping.

17. The method of claim 11, further comprising assembling a solid electrolyte medium between at least two twisted carbon nanofibers.

18. The method of claim 11, wherein the activating and the doping increase at least one of electrical integrity and wettability.

19. A structural supercapacitor comprising:
a plurality of twisted carbon nanofibers,
wherein each twisted carbon nanofiber comprises a porous hollow fiber and metal oxide nanoparticles coated on a surface thereof, and
wherein an outer surface of each twisted carbon nanofiber, an inner surface of each twisted carbon nanofiber, and holes or channels of a main fiber skeleton of the plurality of twisted carbon nanofibers with the possibility of transferring a metal ion are covered by the metal oxide nanoparticles;
an electrolyte medium; and
a current collector.

20. The structural supercapacitor of claim 19, wherein the plurality of twisted carbon nanofibers are doped with heteroatoms.
